(19) United States
(12) Patent Application Publication
(10) Pub. No.: US 2008/0307462 A1
(43) Pub. Date: Dec. 11, 2008

(54) SYSTEMS AND METHODS FOR SEARCHING AND FOR DISPLAYING MEDIA CONTENT

(76) Inventors: Todd Beetcher, Boulder, CO (US); Curt Bruner, Longmont, CO (US); Lance Carlson, Longmont, CO (US); David Feller, Longmont, CO (US); Christopher J. Squires, Westminster, CO (US)

Correspondence Address: Brett Bornsen;Duft Bornsen & Fishman, LLP, Suite 302, 1526 Spruce Street, Boulder, CO, 80302, US

(21) Appl. No.: 11/760,744

(22) Filed: Jun. 9, 2007

(51) Int. Cl. G06F 3/00

(52) U.S. Cl. 725/53

(57) ABSTRACT

Systems and methods are provided for searching and for displaying media content on a display device, such as a television. A user may search for media content while viewing their display device. Further, a user may search multiple sources while viewing their display device to find media content to download, purchase, display, etc., on their display device. Search results are displayed on the display device, with various options available to the user. A user may then download, purchase, view and/or experience selected media content. Thus, users may then experience media content within a short period of time after deciding to acquire the media content. Further, users may view media content from a media server or media unit without preloading the media content on the media unit, and may experience a greater selection of media content.

### RELATED APPLICATIONS

This application is related to U.S. patent application Ser. No. 11/502,051, entitled “MEDIA SYSTEM AND METHOD FOR PURCHASING, DOWNLOADING AND PLAYING MEDIA CONTENT”, which is hereby incorporated by reference.

### BACKGROUND OF THE INVENTION

1. Field of the Invention

The invention relates to media systems, and in particular, to systems and methods for searching and for displaying media content on a display device.

2. Background

Media content, such as movies and music, is stored, distributed and used in many formats. Audio-visual media content, such as movies, is stored and distributed on digital video discs (DVDs). Compact discs (CDs) are a standard media for storing and distributing music files, which are typically audio-only media content. Magnetic and electronic storage devices, such as disk drives and flash memories, are also used for storing media content using formats such as MPEG.

In addition to the various media content storage and distribution formats, there are a variety of media content players. DVDs are typically played on dedicated DVD players connected to televisions or on DVD drives in computers where the media content is displayed on a computer screen. CDs can also be played on computers along with dedicated portable CD players and other audio devices. MP3 (one of the MPEG formats) and MPEG files (e.g., video files) can be played on computers and dedicated MP3 players, as well as on televisions using players capable of generating a signal compatible with a television.

A problem arises because different formats and storage devices for media content require a user to own various types of media players to accommodate the different formats. Thus, a user may need to purchase different types of media players to accommodate different formats of media content. A further problem arises if the user wants to play the media content at different locations in the house. In a house with several televisions, a user needs to own a media player device for each television to easily experience the media content at multiple locations in the house. Otherwise, the user needs to move the media player to different locations in the house, or simply choose to use only a single television to display that particular media content.

Media servers were developed to solve problems with sharing movies, music and other media content between players in a house. Typically, media content is loaded onto the media server and distributed to special set-top boxes throughout the house. For example, a user may purchase a copy of a movie or music on a DVD, CD, or other portable storage device, and then manually install the media content from the portable storage device onto the media server. This may require the user to interact with the media server using an attached screen, mouse and/or keyboard. These systems are cumbersome and time consuming and costly, and do not offer the consumer the ability to enjoy the media content within a short time of deciding to obtain the content.

The user may be limited to only experiencing media content which is preloaded onto the media server. If the user wants to experience media content which is not preloaded onto the media server, then the user needs to get up from the television and manually acquire the media content they desire to experience. The user often lacks the ability to search for and acquire media content while in front of the television, as well as searching for media content using the media server. Further, some media servers allow a user to download or content directly onto the media server, but users are often limited to acquiring media content from a single source. Thus, it is evident from the above discussion that improved solutions are needed for displaying media content on a display device.

### SUMMARY

The invention solves the above and other related problems with improved solutions for searching and displaying media content on a display device, such as a television. A user may search for media content while viewing their display device. Search results are displayed on the display device, with various options available to the viewer. A user may then purchase (if necessary), download and/or view selected media content. Thus, users advantageously may acquire media content within a short period of time after deciding to acquire the media content. Further, users may advantageously experience media content from a media server or media unit without preloading the media content on the media unit, and may access content from multiple sources.

An embodiment of the invention comprises a method for searching and for displaying media content on a display device over an un-modulated service channel of a channel source over a building cable infrastructure. The building cable infrastructure may be a cabling or network system adapted to connect a display device to a channel source (e.g., a cable television system). An un-modulated service channel may be an allocated service channel of the channel source which is not presently used by the channel source to distribute media content. The un-modulated service channel may also be an allocated service channel of the channel source which is selectively filtered to remove signals modulated by the channel source. The method comprises receiving a search request from a user, and identifying media content corresponding with the search request. The method further comprises displaying a description of the media content on the display device over the un-modulated service channel. The method further comprises receiving user input selecting a file of the media content for display on the display device. The method further comprises generating a content stream based on the selected file of the media content, and displaying the content stream on the display device over the un-modulated service channel.

Another embodiment of the invention comprises a method for searching and for displaying media content on a display device. The method comprises receiving a search request from a user, and searching a plurality of media content sources to identify media content corresponding with the search request. The media content sources may provide media content which is available for purchase by the user. Alternatively, the media content may be identified based on an index of available media content for the user. The index may be compiled based on personal characteristics of the user. The method further comprises displaying a description of the media content on the display device, and receiving user input selecting a file of the media content for display on the display device. The method further comprises generating a content stream based on the selected file of the media content, and displaying the content stream on the display device. In another embodiment, the method may further comprise receiving user input indicating a purchase of a file of the media content from one of the media content sources. The content stream may then be generated based on the purchased file of media content. Alternatively, the method may comprise identifying media content of interest to the user based on the index without the user providing a search request, and providing the user with identified media content of interest. The user may then select media content for display on the display device.

Another embodiment of the invention comprises a method for searching and for displaying on a television tangible goods available for purchase using a media unit. The media unit is adapted to provide media content to the television. The method comprises receiving a search request from a user for tangible goods available for purchase. The user inputs the search request using a remote control for the television. The method further comprises identifying tangible goods corresponding with the search request using the media unit, and displaying a description of the tangible goods on the television. The method further comprises receiving user input selecting one of the tangible goods for purchase, and generating a purchase request for the selected tangible good.

The invention may include other exemplary embodiments described below.

### DESCRIPTION OF THE DRAWINGS

The same reference number represents the same element or same type of element on all drawings.

FIG. 1 illustrates a media system for searching and for displaying media content on a display device in an exemplary embodiment of the invention.

FIG. 2 illustrates a more detailed view of the media unit of FIG. 1 in an exemplary embodiment of the invention.

FIG. 3 illustrates a plurality of display devices coupled to the media unit of FIG. 1 in an exemplary embodiment of the invention.

FIG. 4 illustrates another media system for searching and for displaying media content on a display device in an exemplary embodiment of the invention.

FIG. 5 illustrates another media system for searching and for displaying media content on a display device, where the media unit is attached to a computer in an exemplary embodiment of the invention.

FIG. 6 illustrates another media system for searching and for displaying media content on a display device, where the media unit communicates with a receiver box attached to the display device through a wireless connection in an exemplary embodiment of the invention.

FIG. 7 illustrates exemplary details of the remote control of FIGS. 1-6 in an exemplary embodiment of the invention.

FIG. 8 illustrates a method for searching and for displaying media content on a display device over an un-modulated service channel of a building cable infrastructure in an exemplary embodiment of the invention.

FIG. 9 illustrates an exemplary menu displayed to a user while searching for media content in an exemplary embodiment of the invention.

FIG. 10 illustrates an exemplary menu displayed to a user that includes descriptions of media content corresponding with a search request in an exemplary embodiment of the invention.

FIG. 11 illustrates a method for receiving user input for a search request in the form of a voice command in an exemplary embodiment of the invention.

FIG. 12 illustrates a method for receiving user input for a search request in the form of a handwriting sample in an exemplary embodiment of the invention.

FIG. 13 illustrates a method for searching a plurality of media content sources to identify media content for display on a display device in an exemplary embodiment of the invention.

FIG. 14 illustrates a method for identifying media content from a plurality of media content sources in an exemplary embodiment of the invention.

FIG. 15 illustrates an exemplary menu displaying the aggregated descriptions of the media content identified by the method of FIG. 14 in an exemplary embodiment of the invention.

FIG. 16 illustrates a method for downloading media content from a remote content source in an exemplary embodiment of the invention.

FIG. 17 illustrates a method for searching and for displaying media content based on a particular user of a media unit in an exemplary embodiment of the invention.

FIG. 18 illustrates a method for determining media content of interest to a particular user in anticipation of a search request in an exemplary embodiment of the invention.

FIG. 19 illustrates a method for identifying media content of interest to a user in an exemplary embodiment of the invention.

FIG. 20 illustrates a method for identifying media content of interest to a user based on a frequency of viewing of types of media content by the user in an exemplary embodiment of the invention.

FIG. 21 illustrates a method for identifying media content of interest to a user based on the last media content viewed by the user in an exemplary embodiment of the invention.

FIG. 22 illustrates a method for searching and for displaying media content available for purchase from a plurality of media content sources in an exemplary embodiment of the invention.

FIG. 23 illustrates an exemplary menu displaying media content identified as available for purchase by the method of FIG. 22 in an exemplary embodiment of the invention.

FIG. 24 illustrates a method for purchasing media content using a debit account of a user of a media unit in an exemplary embodiment of the invention.

FIG. 25 illustrates a method for searching and for displaying on a display device tangible goods available for purchase in an exemplary embodiment of the invention.

FIG. 26 illustrates an exemplary menu displaying media content, corresponding with a search request, which is available for display on a display device, and displaying tangible goods available for purchase which correspond to the search request in an exemplary embodiment of the invention.

FIG. 27 illustrates an exemplary menu displaying tangible goods available for purchase which correspond to the search request in an exemplary embodiment of the invention.

FIG. 28 illustrates a method for completing a purchase of tangible goods identified as available for purchase by the method of FIG. 25 in an exemplary embodiment of the invention.

### DETAILED DESCRIPTION OF THE INVENTION

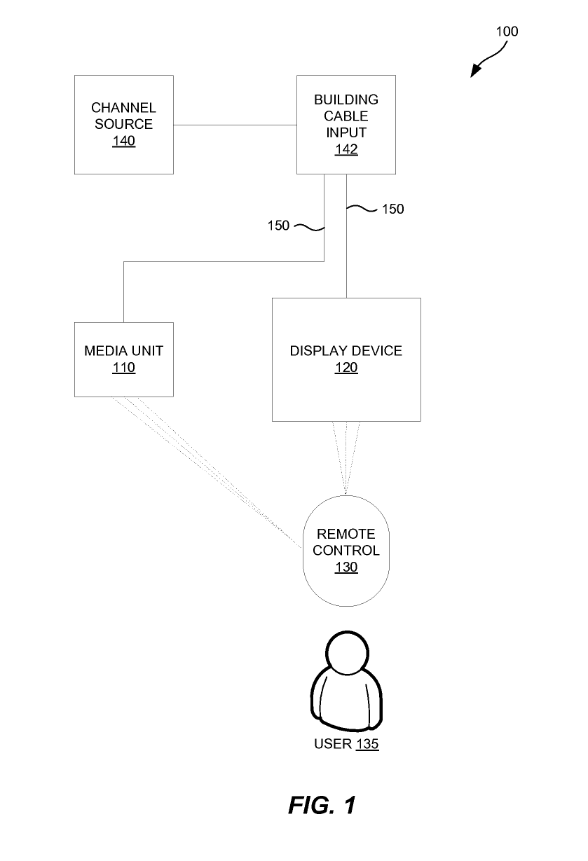

FIGS. 1-28 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a media system 100 for searching and for displaying media content on a display device in an exemplary embodiment of the invention. Media system 100 includes a display device 120 for displaying media content, and other information, such as search menus, preferences menus, downloading and purchasing menus, etc. Display device 120 may be a television, or any other type of suitable system adapted to display media content to a user 135. Display device 120 is adapted to display and play different types of media content, for example audio content and music, pictures, television broadcasts, digitally-formatted videos, etc. Media content may be locally-stored within media unit 110, or downloaded or retrieved from peripheral devices, the internet, remote content sources, etc. Media content may be stored as one or more media files, such as MPEG files, GIFs, JPEGs, DVD videos, etc.

In one embodiment, display device 120 is connected to a building cable infrastructure 150. Building cable infrastructure 150 may be any cabling or network system adapted to connect a display device 120 to a television signal source. For example, building cable infrastructure 150 may be a coaxial cable infrastructure present in many buildings which allows a television to connect to a cable system, satellite dish, antenna, etc. Building cable infrastructure 150 may connect to building cable input 142, which connects building cable infrastructure 150 to a channel source 140. Display device 120 may alternatively connect to channel source 140 through a wireless network (not shown).

Channel source 140 provides display device 120 with one or more modulated service channels. Service channels are specific frequency bands corresponding with FCC-allocated channels for broadcast or cable television. While the present application refers to broadcasts and cable television systems, those of ordinary skill in the art will recognize that the systems, devices and methods described herein may also be applied to display devices and media systems which receive television signals and media content through satellite dishes, antennas and other types of receivers. Thus, signals from broadcasts, cable and other types of channel services are herein referred to as service channels. Further, channel source refers to any type of source of service channels.

Display device 120 receives one or more signals corresponding with one or more service channels, and is adapted to selectively tune and demodulate the frequency band corresponding with a service channel to reproduce the audio and/or video content contained within the service channel signal. Display device 120 may also receive a signal carrying media content from a device or network, such as using an Ethernet connection or video cables. Channel source 140 may use only a portion of the allocated channels, while leaving some channels unused. Therefore, service channels include modulated service channels which are used by channel source 140, and un-modulated service channels, which are not used by channel source 140. The modulated service channels are modulated with media content, such as audio and visual media from television stations, radio stations, cable providers, etc.

Media system 100 includes media unit 110, which is adapted to search for and/or to display media content on display device 120. Media unit 110 may be connected to display device 120 through building cable infrastructure 150. Thus, media unit 110 may connect to display device 120 using the existing building cable infrastructure 150, and does not require the use of additional hardware or cabling. However, those of ordinary skill in the art will recognize that media unit 110 may be connected to display device 120 through other connections, such as wireless connections, S-video connections, RCA video connections, etc.

To display media content on display device 120, media unit 110 may modulate media content over an allocated channel of channel source 140. Preferably, media unit 110 utilizes an un-modulated service channel of channel source 140. For example, if channel 73 corresponds to an unused service channel of channel source 140, then media unit 110 may modulate media content over channel 73, and display device 120 to may be tuned to channel 73 in order for display device 120 to receive and to display the media content. User 135 may manually tune display device 120 to the un-modulated channel, or media unit 110 and/or remote control 130 (to be described below) may automatically perform the tuning process responsive to a user selecting to view media content from media unit 110.

If channel source 140 includes no un-modulated service channels (i.e., all of the service channels are presently used), then media unit 110 may utilize a modulated service channel of channel source 140 for displaying media content. In this configuration, media unit 110 may be connected to building cable input 142 to receive signals corresponding with the service channels of channel source 140. Display device 120 may then couple to media unit 110 to receive signals corresponding with the service channels of channel source 140. Media unit 110 may selectively filter one or more service channels of channel source 140, and use a filtered service channel to display media content on display device 120. The filtering may be performed by a supercombiner (not shown) coupled to or built in to building cable input 142. Filtering may be performed by the supercombiner responsive to commands by media unit 110. For example, user 135 may select a modulated service channel of channel source 140 for use by media unit 110 (e.g., channel 73), and media unit 110 and/or the supercombiner of building cable input 142 may filter the frequency corresponding with the selected service channel from the signal transmitted by channel source 140 before the signal reaches display device 120 (i.e., media unit 110 may remove the selected service channel from the signal).

Media system 100 further includes a remote control 130 for user 135 to control display device 120 and/or media unit 110. User 135 may use remote control 130 to interact with menus displayed on display device 120 by media unit 110. Remote control 130 may include buttons which may be used for manipulating the menus. The menus may allow user 135 to search for media content for display on display device 120, as well as purchase and/or download media content from remote content sources, peripheral devices, etc. Remote control 130 may communicate with display device 120 and media unit 110 using infrared or radio frequency (“RF”) communications. Media system 100 may include other components not shown for the sake of brevity.

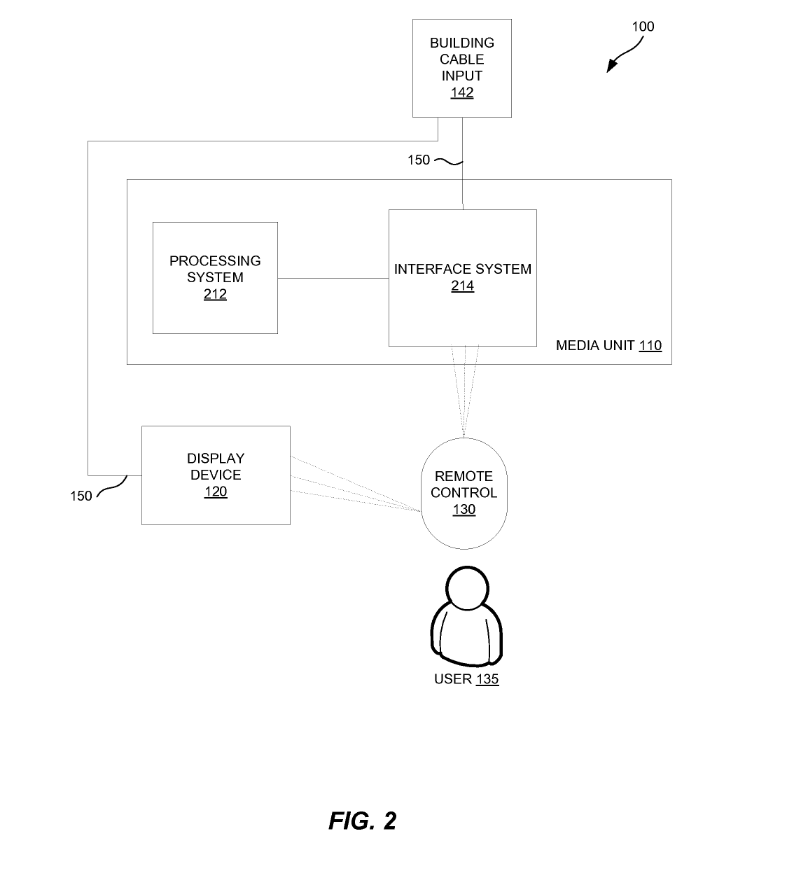

FIG. 2 illustrates a more detailed view of media unit 110 of FIG. 1 in an exemplary embodiment of the invention. Media unit 110 includes interface system 214 adapted to communicate with remote control 130 operated by user 135. Interface system 214 may communicate with remote control 130 using infrared or RF communications. Remote control 130 receives input from user 135, and transmits the input to interface system 214 for further processing by media unit 110. Remote control 130 may translate the input into a format utilized by media unit 110 for searching and displaying media content prior to transmitting the input to interface system 214. Alternatively, remote control 130 may transmit the input to interface system 214, and media unit 110 may then translate the input into a format utilized by media unit 110. Interface system 214 may further interface with other input devices, such as keyboards, mice, computers, PDAs, cell phones, etc.

Media unit 110 further includes a processing system 212 adapted to search for media content and to display the media content on display device 120. Processing system 212 refers to a single processing device or a group of inter-operational processing devices. The operation of processing system 212 may be controlled by instructions executable by processing system 212. Some examples of instructions are software, program code, and firmware. Processing system 212 translates media content from any type of transmitted, downloaded or stored format into a format utilized by display device 120. For example, processing system 212 may modulate a digital video onto a service channel over building cable infrastructure 150 for reception and display by display device 120.

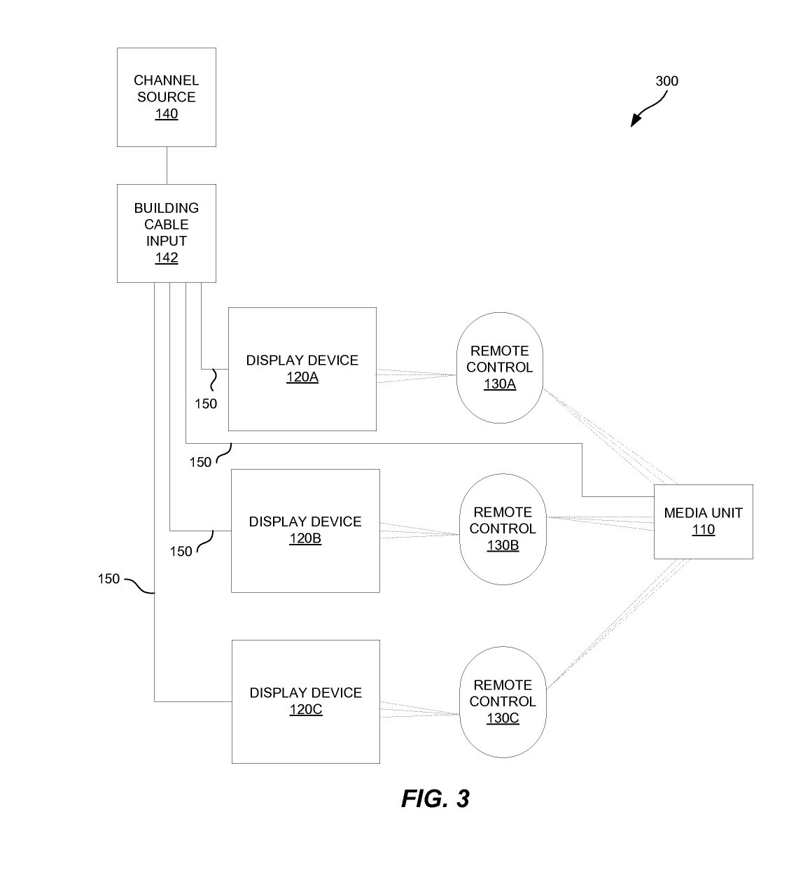

FIG. 3 illustrates a plurality of display devices 120A, 120B and 120C coupled to media unit 110 in an exemplary embodiment of the invention. Using a plurality of un-modulated service channels of channel source 140, media unit 110 may display media content on multiple display devices 120A, 120B and 120C at the same time. For example, channel source 140 may have three un-modulated service channels 52, 61 and 78. Media unit 110 may modulate media content, such as a first movie, onto channel 52 using building cable infrastructure 150. Media unit 110 may modulate a second movie onto channel 61, and may modulate a third movie onto channel 78. A user of display device 120A may use remote control 130A to tune display device 120A to channel 52 to view the first movie. Likewise, a user of display device 120B may use remote control 130B to tune display device 120B to channel 61 to view the second movie, and a user of display device 120C may use remote control 130C to tune display device 120C to channel 78 to view the third movie.

The tuning process may be transparent to the user. For example, assume that remote control 130 has a button for viewing media content on media unit 110. Media unit 110 and/or remote control 130 may automatically identify an un-modulated channel and tune display device 120 to the un-modulated channel. Additionally, two or more display devices 120 may be tuned to the same channel to display the same media content. For example, if display device 120A and display device 120B are both tuned to channel 52 at the same time, then display devices 120A and 120B will display the same media content.

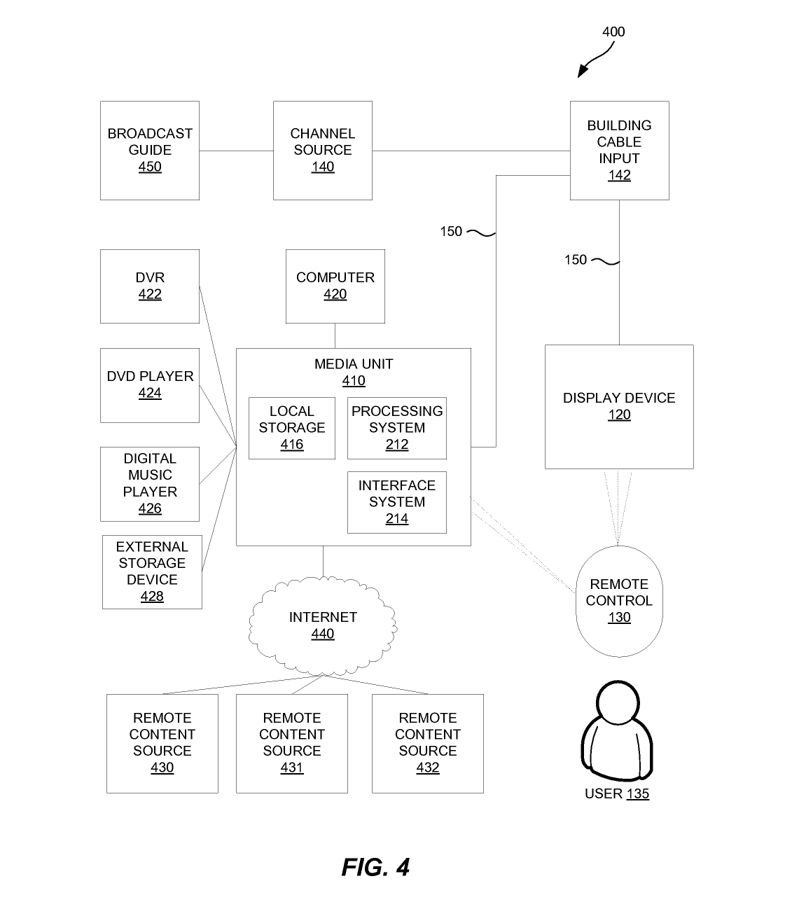

FIG. 4 illustrates a media system 400 for searching and for displaying media content on a display device 120 in an exemplary embodiment of the invention. Media unit 410 may be connected to building cable infrastructure 150 through building cable input 142. Media unit 410 may be similar to media unit 110 of FIG. 1, and includes local storage 416 for storing media content for present or future viewing or playback. Media unit 410 may be connected to a plurality of peripheral devices, such as a computer 420, a digital video recorder (DVR) 422, a digital video disk (DVD) player 424 or other type of optical disk player, a digital music player 426, or an external storage device 428, such as a USB flash drive storing pictures, music, videos, etc. Media unit 410 may retrieve media content from any of the peripheral devices, and modulate the media content onto an un-modulated service channel for display on display device 120.

Media unit 410 may also connect to one or more remote content sources 430-432 through internet 440 or other type of network used for distributing media content for display on display device 120. Media unit 410 may download media content from remote content sources 430-432, and may persistently store the media content on local storage 416 for later use. Alternatively, media unit 410 may buffer media content from remote content sources 430-432 for display on display device 120 during the present viewing session of user 135, but media unit 410 may not persistently store the buffered media content for later use.

Remote content sources 430-432 may be any type of servers, services or devices for providing media content to media unit 410. For example, remote content sources 430-432 may be vendors of media content, and user 135 may purchase media content from one or more remote content sources 430-432 for display on display device 120. One of remote content sources 430-432 may also comprise a media search engine which aggregates descriptions of media content from a plurality of other remote content sources 430-432, and then provides the descriptions of the media content to media unit 410 responsive to a search request from user 135. Thus, user 135 may search media content from a variety of sources, and then select media content from one or more of the sources for viewing on display device 120. Remote content sources 430-432 may also be adapted to provide downloads of media content, buffered media content, etc.

Media system 400 also includes a broadcast guide 450, which is adapted to provide information regarding television programs available over service channels of channel source 140. Broadcast guide 450 may be connected to channel source 140 and/or media unit 410. Broadcast guide 450 may be a service provided by channel source 140, or may be an external service available through internet 440 or other type of network. Media unit 410 queries broadcast guide 450 to determine television programs corresponding with a search request from user 135 that are available for viewing on display device 120.

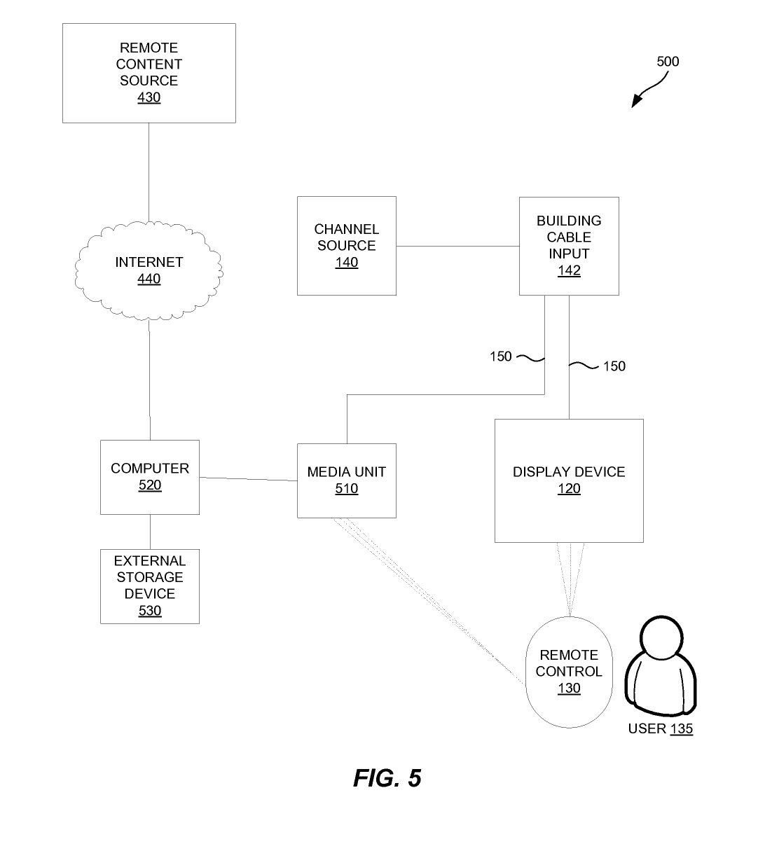

FIG. 5 illustrates a media system 500 in an exemplary embodiment of the invention. Media unit 510 may be similar to media unit 110 of FIG. 1 or media unit 410 of FIG. 1, and is connected to computer 520 to leverage the networking and/or storage capabilities of computer 520. Thus, when media unit 510 receives a search request from remote control 130, media unit 510 may access remote content source 430 through computer 520. Computer 520 is connected to remote content source 430 through internet 440. Computer 520 may execute special software for interfacing with media unit 510 and remote content source 430.

Media unit 510 may further store and access media content stored on computer 520. For example, computer 520 may store movies, music, pictures, etc., on a local storage device of computer 520. When user 135 initiates a search request for media content, media unit 510 may identify corresponding media content on computer 520, and display descriptions of the identified media content on display device 120. If user 135 desires to experience media content stored on computer 520, then media unit 510 may access the media content from computer 520, or an external storage device 530 connected to computer 520, and generate a content stream from the media content for display on display device 120.

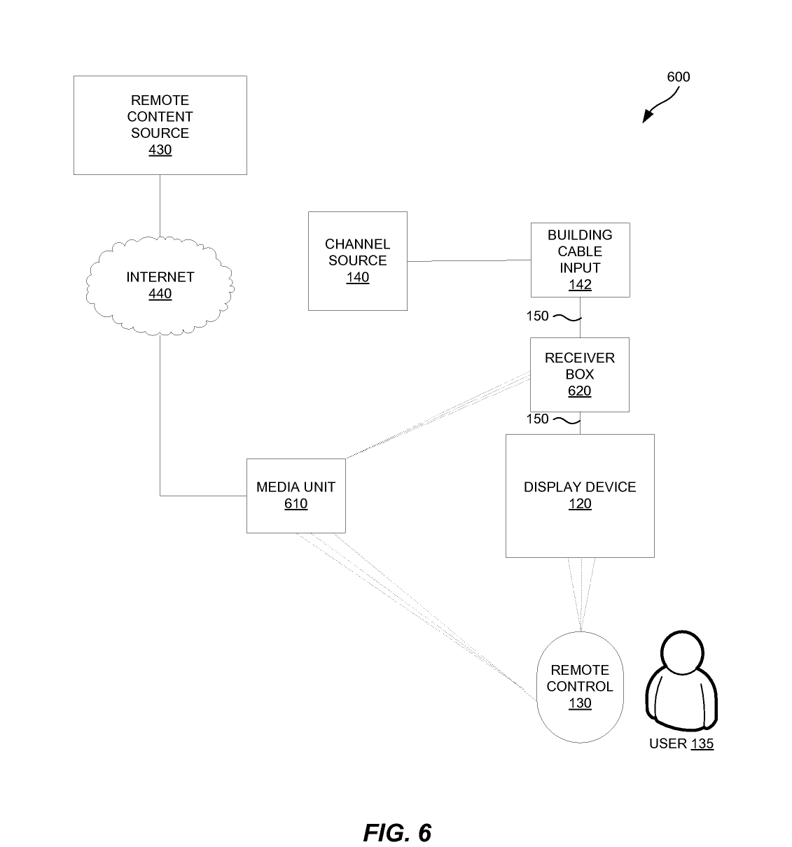

FIG. 6 illustrates another media system 600 for searching and for displaying media content on a display device 120. Media unit 610 may be similar to media unit 110 of FIG. 1, media unit 410 of FIG. 4, or media unit 510 of FIG. 5. Media unit 610 communicates with a receiver box 620 attached to display device 120 through a wireless connection. Receiver box 620 is attached to display device 120 using standard audio and/or video connectors, such as coax cable, an RCA connector, an HDMI connector, etc. For example, receiver box 620 and display device 610 may communicate using a Multimedia over Cable Alliance “MOCA” connection.

Receiver box 620 includes a transmitter/receiver to communicate with media unit 610 through a wireless connection. Alternatively, media unit 610 may be connected to receiver box 620 through a wired connection, such as Ethernet, coax or video cables. Receiver box 620 may be connected to a remote content source 430 through internet 440 to receive media content. In one embodiment, media unit 610 may be connected to a computer (not shown). Thus, media unit 610 may generate a content stream from media content received from remote content source 430 or the computer (not shown). Media unit 610 may transmit menus, media content, and other information to receiver box 620 over the wireless connection. Receiver box 620 may then produce output for display on display device 120 based on the data received from media unit 610.

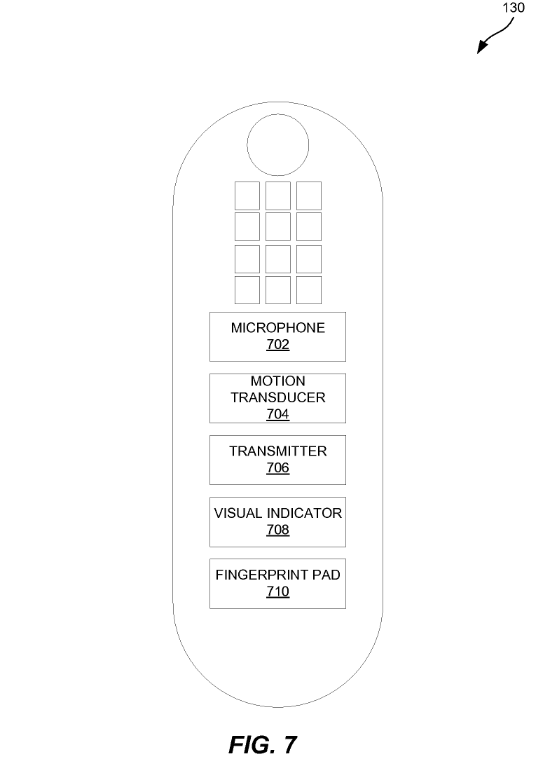

FIG. 7 illustrates a remote control 130 of FIGS. 1-6 in an exemplary embodiment of the invention. Remote control 130 will be described in reference to media unit 110 of FIG. 1. However, remote control 130 may also be used in conjunction with media unit 410 of FIG. 1, media unit 510 of FIG. 5, or media unit 610 of FIG. 6. User 135 uses remote control 130 to control media unit 110 for searching, downloading, purchasing and/or displaying media content. Remote control 130 may include a plurality of buttons, some of which may be related to navigation of menus displayed by media unit 110. User 135 views various menus on display device 120, and presses one or more buttons on remote control 130 to search, purchase, download or control the display of media content on display device 120.

Remote control 130 includes a transmitter 706 for communicating with media unit 110 through an RF communication link and/or other type of wireless link, such as an infrared communication link. Transmitter 706 of remote control 130 may also communicate with and control display device 120 through a wireless communication link. Some of the buttons on remote control 130 may be used for controlling functions of display device 120, as well as peripheral devices, such as DVR 422, DVD player 424, digital music player 426, external storage device 428 or computer 420.

In some embodiments of the present invention, remote control 130 may include a microphone 702 adapted to receive voice commands and voiceprint samples from user 135. Microphone 702 may include processing circuitry adapted to translate the voice commands and voiceprint samples from user 135 into formats used by media unit 110. Alternatively, remote control 130 may transmit the received voice commands and voiceprint samples to media unit 110 for further processing and translation into a format utilized by media unit 110.

In some embodiments, remote control 130 may include a motion transducer 704 adapted to receive user input, such as a handwriting sample or other image from user 135. In one embodiment, motion transducer 704 is an accelerometer. Motion transducer 704 allows user 135 to use remote control 130 to input information into media unit 110. As used herein, a handwriting sample comprises handwritten input from the user, including words, characters, numbers and/or images. For example, user 135 may use remote control 130 to write the name of a movie that user 135 desires to view on display device 120. User 135 writes the name of the movie by moving or waving remote control 130 as if remote control 130 were a pen or other writing device. The handwriting sample is then translated into a format utilized by media unit 110, such as ASCII. Motion transducer 704 may include processing circuitry adapted to translate the input into a format utilized by media unit 110. Alternatively, motion transducer 704 may collect information related to the handwriting sample, and remote control 130 may transmit the collected information to media unit 110 for further processing and translation into a format utilized by media unit 110.

Remote control 130 may also include a fingerprint pad 710 adapted to receive a fingerprint sample from user 135. User 135 makes contact with fingerprint pad 710, and fingerprint pad 710 takes a fingerprint sample from user 135. The fingerprint sample may then be processed to identify user 135. Fingerprint pad 710 may include processing circuitry adapted to identify user 135, or such identification may be executed by processing system 212 of media unit 110.

Remote control 130 may also include a visual indicator 708. In one embodiment, visual indicator 708 may be a light emitting diode (“LED”), which is adapted to notify user 135 of events regarding media unit 110. For example, media unit 110 may activate visual indicator 708 responsive to completing a download of a file of media content, or responsive to completing a predetermined partial download such that enough media content has been buffered to start uninterrupted playback. Additionally, visual indicator 708 may be adapted to notify a user 135 of other events regarding user 135. For example, user 135 may be notified of a status change regarding an auction of an electronic auction service. Remote control 130 may alternatively include an audio indicator (not shown), which is adapted to notify user 135 of events regarding media unit 110, or other type of indicator (such as a vibrating indicator). In some embodiments, remote control 130 may include a combination of visual indicator 708 and an audio indicator (not shown). Those of ordinary skill in the art will recognize that remote control 130 may include any combination of the components illustrated in FIG. 7 depending on desired design criteria of media unit 110 and remote control 130.

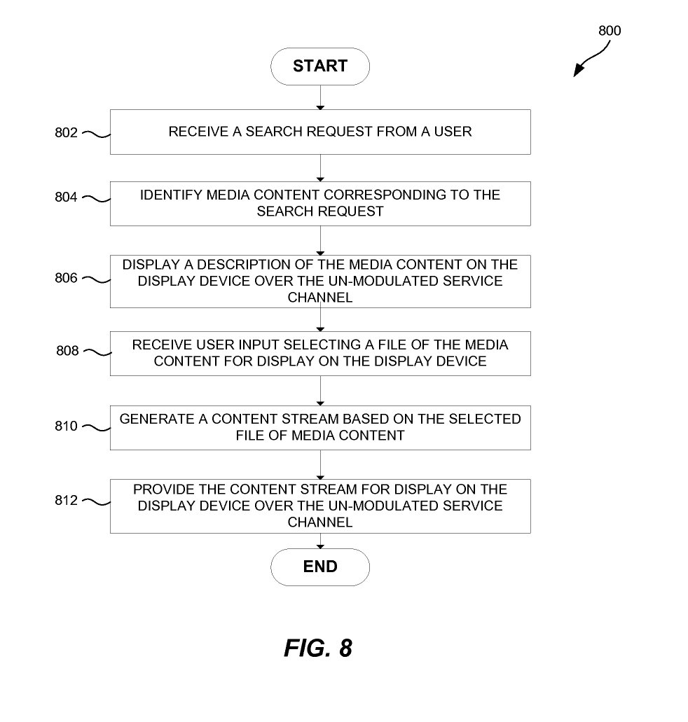

FIG. 8 illustrates a method 800 for searching and for displaying media content on a display device 120 over an un-modulated service channel of a building cable infrastructure 150 in an exemplary embodiment of the invention. The steps of method 800 will be described in reference to media system 100 illustrated in FIGS. 1 and 2. The steps of method 800 are not all-inclusive, and may include other steps not shown for the sake of brevity.

In step 802 of FIG. 8, interface system 214 receives a search request from user 135 through remote control 130. The search request may indicate a particular type of media content that user 135 desires to experience or display on display device 120, such as movies, television programs, music, pictures, etc. The search request may also indicate a particular genre of media content, such as children's programming, action movies, comedies, horror movies, etc. The search request may also indicate keywords regarding specific media content user 135 desires to experience. User 135 may enter a search request through one or more menus displayed on display device 120, and user 135 may use remote control 130 to navigate the menus.

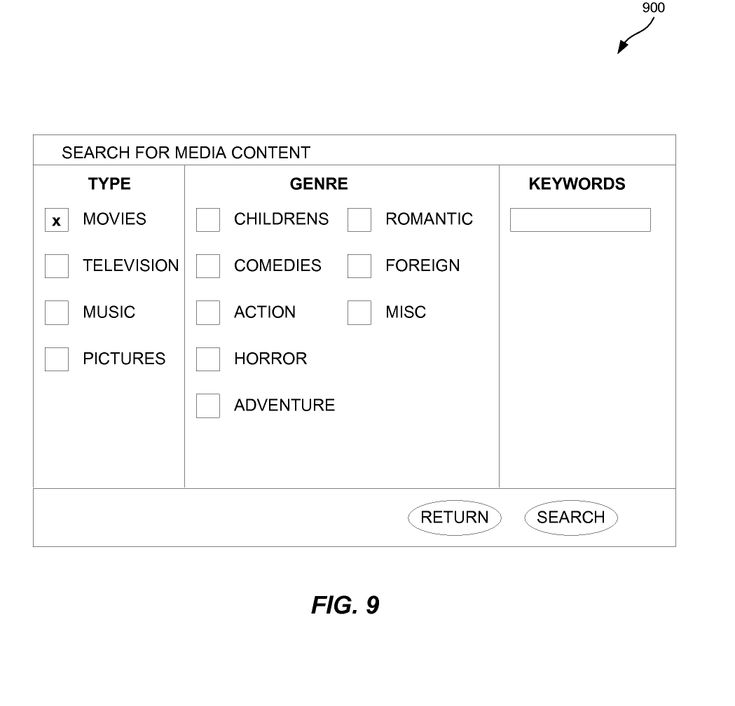

FIG. 9 illustrates an exemplary menu 900 displayed to user 135 while searching for media content in an exemplary embodiment of the invention. More specifically, menu 900 illustrates a search menu allowing user 135 to select a category of media content (e.g., movies), and a genre corresponding with the selected category that user 135 desires to experience. As user 135 selects a category by checking a corresponding checkbox, the contents of the genre panel may change to reflect the genres available for the selected category. For example, when the “movies” category is selected, the available genres may include comedy, action, foreign, romantic, etc. However, when the “television” category is selected, exemplary genres may include sports, news, children's programming, documentaries, comedy, etc.

In step 804 of FIG. 8, processing system 212 identifies media content corresponding with the search request. Processing system 212 may find media content which is an exact match to the search request, may find media content which is similar to the search request, etc. Those of ordinary skill in the art will recognize a variety of searching and/or identification techniques for identifying the media content corresponding with the search request. Processing system 212 may identify media content from a plurality of media content sources, such as searching locally-stored media content, remotely-provided media content, a television guide, etc. For example, if the search request indicates “action”, then processing system 212 may search a plurality of media content sources to identify action movies available for viewing on display device 120 by user 135.

In step 806 of FIG. 8, processing system 212 displays a description of the identified media content on display device 120 over the un-modulated service channel. To display the description of the media content, processing system 212 modulates a menu (including the descriptions of the media content) over the un-modulated service channel. Display device 120 displays the content of the un-modulated service channel to user 135, and user 135 may use remote control 130 to navigate the menu.

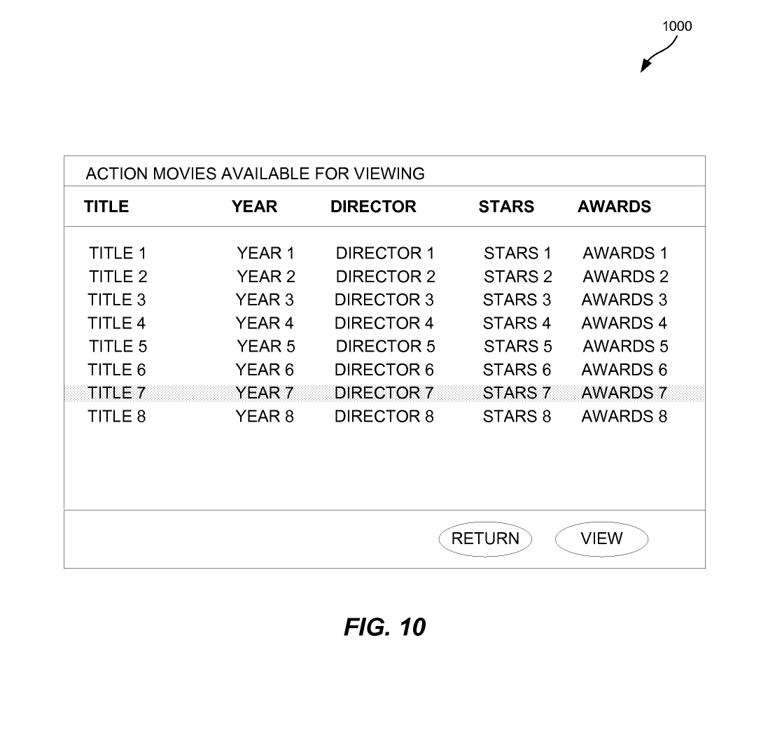

FIG. 10 illustrates an exemplary menu 1000 displayed to user 135 that includes descriptions of media content corresponding with a search request in an exemplary embodiment of the invention. More specifically, menu 1000 illustrates descriptions of action movies identified responsive to a search request initiated by user 135. User 135 may select to experience one of the files of media content on display device 120 using menu 1000 of FIG. 10 by highlighting the desired file and pressing the “View” button.

In step 808 of FIG. 8, interface system 214 receives user input selecting a file of media content for display on display device 120. In step 810 of FIG. 8, processing system 212 generates a content stream based on the selected file of media content selected in step 808. For example, assume that user 135 selects “Title 7” in menu 1000. Processing system 212 then generates a content stream based on the contents of the file corresponding with “Title 7”. In step 812, processing system 212 provides the content stream for display on display device 120 over the un-modulated service channel.

User 135 may provide a search request using a variety of input techniques. For example, user 135 may navigate a menu (e.g., menu 900 of FIG. 9 and menu 1000 of FIG. 10) using directional pads and/or other buttons of a standard or specially designed television remote (e.g., remote control 130 of FIGS. 1-6). To enter alphanumeric information, such as the name of a movie, media unit 110 may overlay a display of an alphanumeric keyboard onto display device 120, and user 135 may use buttons of remote control 130 to navigate the keyboard on display device 120 to enter the keywords.

Alternatively, remote control 130 may allow user 135 to enter alphanumeric information using a multi-tapping or a text-on-nine system, where numerical buttons correspond to specific letters of the alphabet or other characters. For example, the “2” button corresponds to the letters A, B and C. User 135 may press the “2” button once for the letter A, twice for the letter B and three times for the letter C. The entered characters may then appear in a search box of a menu (e.g., menu 900 of FIG. 9) displayed on display device 120 as user 135 enters information into remote control 130.

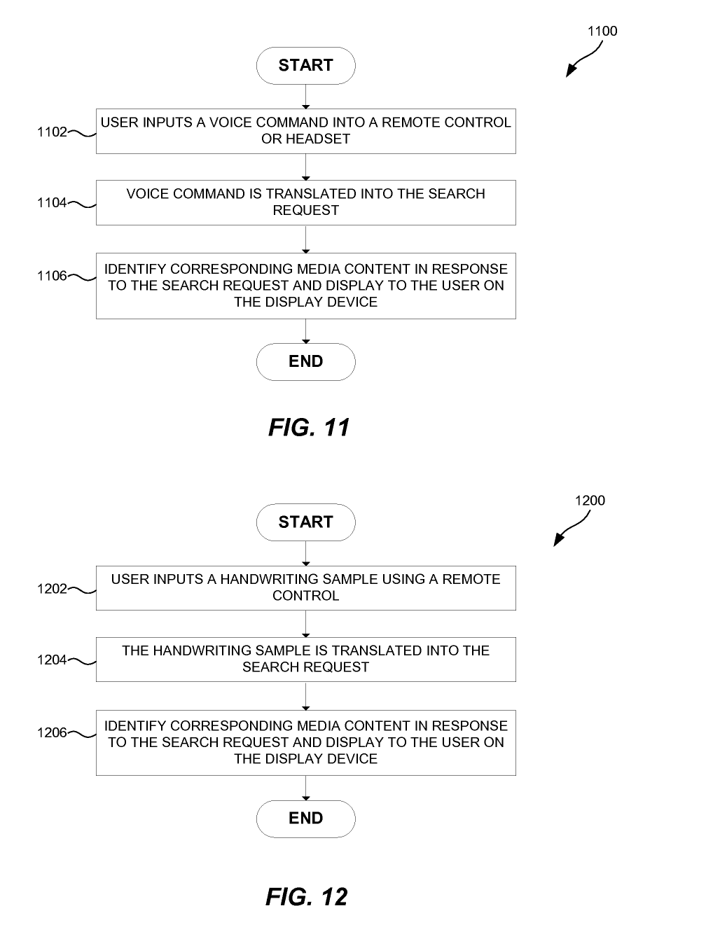

In another alternative embodiment, user 135 may input a search request using a voice command, and the voice command may be translated into a format used by media unit 110 to identify media content corresponding with the search request. FIG. 11 illustrates a method 1100 for receiving user input of a search request in the form of a voice command in an exemplary embodiment of the invention. The steps of method 1100 will be described in reference to media system 100 of FIGS. 1 and 2, and in reference to remote control 130 of FIG. 7. The steps of method 1100 are not all-inclusive, and may include other steps not shown for the sake of brevity.

In step 1102 of FIG. 11, user 135 inputs a voice command into remote control 130 or headset (not shown). Remote control 130 may include a microphone 702 adapted to receive the voice command input from user 135. Remote control 130 transmits data representing the voice command to interface system 214 for further processing. Alternatively, a headset of user 135 may be in signal communication with media unit 410 (see FIG. 4) and transmit voice commands to media unit 410. In step 1104 of FIG. 11, processing system 212 translates the voice command into the search request. Alternatively, remote control 130 may translate the voice command into the search request prior to transmitting the data to interface system 214. In step 1106 of FIG. 11, processing system 212 identifies media content corresponding with the search request, and displays descriptions of the identified media content to user 135 on display device 120.

In another alternative embodiment, user 135 may input a search request using a handwriting sample (e.g., by waving remote control 130 as if user 135 were writing on paper or on a wall), and the handwriting sample may be translated into a format used by media unit 110 to identify media content corresponding with the search request. FIG. 12 illustrates a method 1200 for receiving user input of a search request in the form of a handwriting sample in an exemplary embodiment of the invention. The steps of method 1200 will be described in reference to media system 100 of FIGS. 1 and 2, and in reference to remote control 130 of FIG. 7. The steps of method 1200 are not all-inclusive, and may include other steps not shown for the sake of brevity.

In step 1202 of FIG. 12, user 135 inputs a handwriting sample using remote control 130. Remote control 130 may include a motion transducer 704 which is adapted to determine characters and other images inputted by user 135 as remote control 130 is moved by user 135. In step 1204 of FIG. 12, processing system 212 translates the handwriting sample into the search request. For example, user 135 may desire to enter the term “football” as the search request. User 135 would move remote control 130 to write the word football, and motion transducer 704 would collect data relating to the characters entered. Processing system 212 then translates each character of the word into a corresponding format utilized for identifying media content. Alternatively, remote control 130 may translate the handwriting sample into the search request prior to transmitting data to interface system 214. Media unit 110 may display the lines “drawn” by user 135 on display device 120, or the translated character representations of the handwriting sample on display device 120 as user 135 inputs the information to provide real time feedback to user 135. In step 1206 of FIG. 12, processing system 212 identifies media content responsive to the search request, and displays descriptions of the media content to user 135 on display device 120.

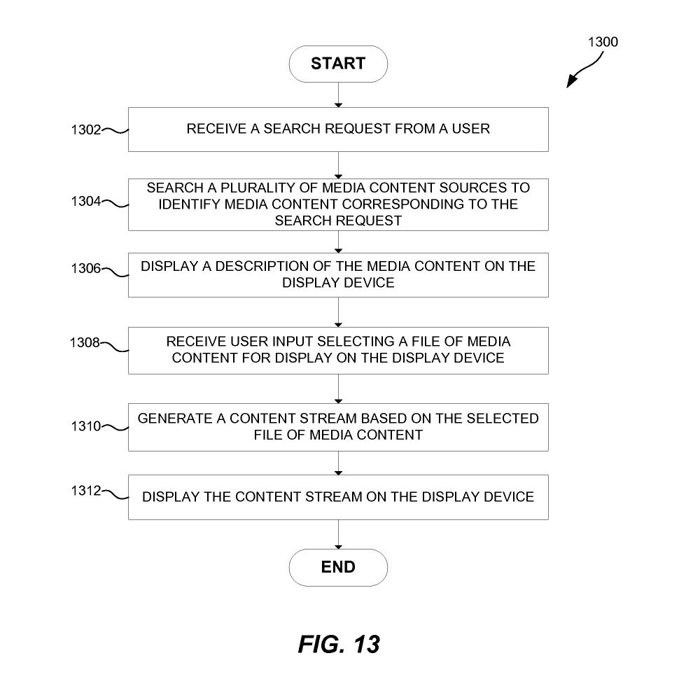

Media unit 110 may search a plurality of media content sources to identify media content corresponding with a search request. Thus, user 135 is not limited to experiencing locally-stored media content or media content available from only a single source (e.g., a single vendor, such as a cable provider). FIG. 13 illustrates a method 1300 for searching a plurality of media content sources to identify media content for display on display device 120 in an exemplary embodiment of the invention. Method 1300 will be discussed in reference to media system 400 of FIG. 4. The steps of method 1300 are not all-inclusive, and may include other steps not shown for the sake of brevity.

In step 1302 of FIG. 13, interface system 214 receives a search request from user 135. The search request may indicate any type of criteria for identifying media content that user 135 desires to experience on display device 120 of FIG. 13. In step 1304, processing system 212 searches a plurality of media content sources (e.g. remote content sources 430-432) to identify media content corresponding with the search request.

As used herein, a plurality of media content sources includes multiple sources providing media content that is both locally-stored and remotely-provided to media unit 410. More specifically, a plurality of media content sources includes a multiple of: local media content sources (e.g., a local hard drive of media unit 410), remote sources providing non-broadcast media content (e.g., media content available for download), and remote sources providing broadcast media content (e.g., a cable television provider). While a cable television provider (e.g., channel source 140) typically provides media content from multiple sources (e.g., multiple channels of media content), for purposes of this application, channel source 140 is considered a single media content source which may provide multiple channels of media content.

In step 1306 of FIG. 13, processing system 212 displays a description of the identified media content on display device 120. In step 1308 of FIG. 13, interface system 214 receives user input selecting a file of media content for display on display device 120. In step 1310 of FIG. 13, processing system 212 generates a content stream based on the selected media file, and in step 1312, displays the content stream on display device 120.

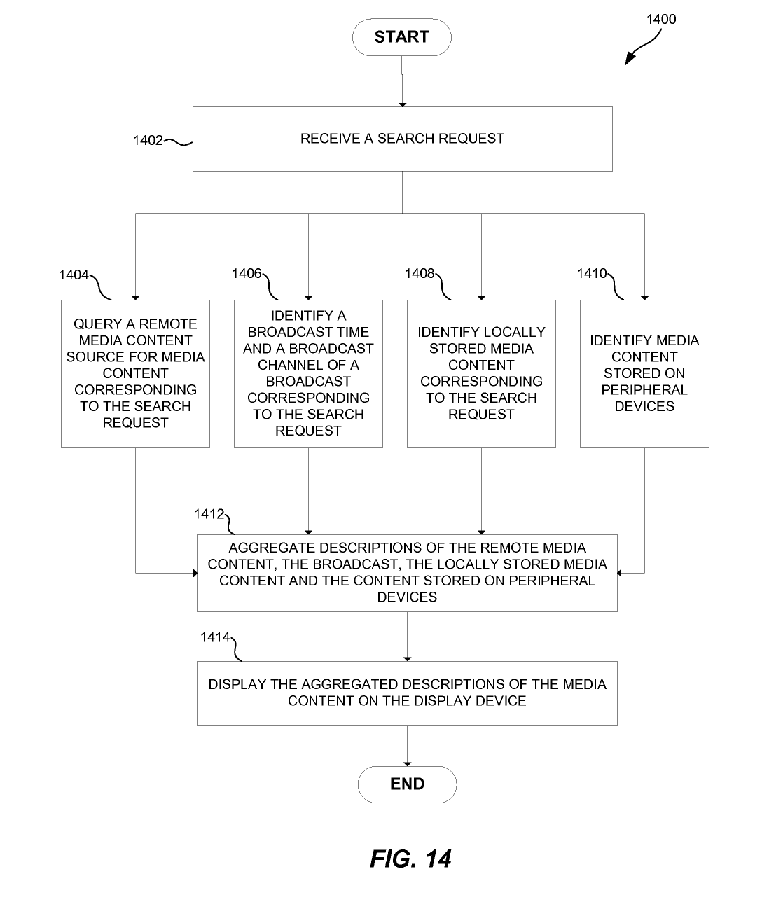

Media content sources may include locally-stored media content on local storage 416 of media unit 410, a television broadcast over a service channel of channel source 140, remotely sourced or remotely stored media content from remote content sources 430-432, media content stored on a computer 420 or other peripheral devices (e.g., DVR 422, DVD player 424, digital music player 426, external storage device 428). FIG. 14 illustrates a method 1400 for identifying media content from a plurality of media content sources in an exemplary embodiment of the invention. The steps of method 1400 will be described in reference to media system 400 of FIG. 4. The steps of method 1400 are not all-inclusive, and may include other steps not shown for the sake of brevity.

In step 1402 of FIG. 14, interface system 214 receives a search request from user 135. To provide a unified menu of media content to user 135 responsive to the search request, processing system 212 may concurrently, sequentially or simultaneously identify media content stored on a plurality of media content sources, and present media content corresponding with the search request to user 135 on display device 120. Assume for example that the search request indicates a particular movie that user 135 desires to view.

In step 1404 of FIG. 14, processing system 212 queries one or more remote content sources 430-432 for content corresponding with the search request. For example, remote content sources 430-432 may be vendors of media content, such as movies. Processing system 212 may query remote content sources 430-432 to determine whether the movie specified in the search request is available for purchase from one or more of the remote content sources 430-432.

In step 1406 of FIG. 14, processing system 212 identifies a broadcast time and a broadcast channel of a broadcast corresponding with the search request. Processing system 212 may determine whether the media content corresponding with the search request is presently available for viewing on a service channel of channel source 140 (see FIG. 4), or whether the media content corresponding with the search request will be available for viewing on a service channel of channel source 140 in the near future.

For example, processing system 212 may query broadcast guide 450 to determine whether the specified movie is available for viewing on a service channel of channel source 140. Processing system 212 may additionally determine whether the movie will be available within a pre-determined time window (e.g., within 30 minutes). The pre-determined time window may be a setting determined by user 135 or processing system 212. Further, the pre-determined time window may be customizable by user 135 on a per-search request basis. For example, in some situations, user 135 may want to check broadcasts within 30 minutes if they are ready to presently watch a movie, but in other situations, the pre-determined time window may be much longer if user 135 is not necessarily interested in watching the movie at the present time, but would like to watch the movie in the future (e.g., later in the day, or in the next few days).

In step 1408 of FIG. 14, processing system 212 identifies locally-stored media content corresponding with the search request. Locally-stored media content may be stored on local storage 416 of media unit 410. Processing system 212 may then identify that a copy of the specified movie is presently stored on local storage 416.

In step 1410 of FIG. 14, processing system 212 identifies media content stored on peripheral devices of media unit 410. For example, processing system 212 may identify that a copy of the movie is stored on computer 420. Alternatively, processing system 212 may identify that a copy of the movie is stored on DVR 424, or that a DVD of the movie is available in DVD player 424 (such as a DVD jukebox).

In step 1412 of FIG. 14, processing system 212 aggregates descriptions of the remote media content identified in step 1404, the broadcast identified in step 1406, the locally-stored media content identified in step 1408, and the media content stored on peripheral devices identified in step 1410 and generates a menu of the identified media content. In step 1414, processing system 212 displays the aggregated descriptions of the media content (e.g., the menu) on display device 120.

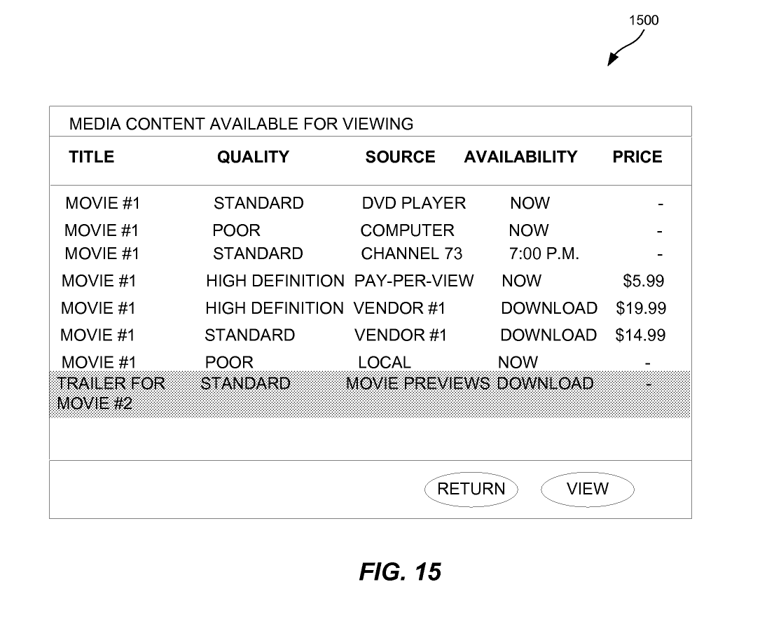

FIG. 15 illustrates an exemplary menu 1500 displaying the aggregated descriptions of the media content identified by method 1400 of FIG. 14 in an exemplary embodiment of the invention. Menu 1500 provides user 135 with a variety of viewing options. User 135 may immediately view “Movie #1” from DVD player 424, computer 420, or local storage 416 of media unit 410. User 135 may also view “Movie #1” for free on channel 73 at 7:00, or pay to view “Movie #1” in high-definition immediately. Further, user 135 is presented with several options to purchase and download “Movie #1” in various qualities from a vendor (e.g., remote content source 430). Thus, even though user 135 has copies of movie in standard definition, if user 135 wants to view the movie in high-definition, user 135 can purchase the movie from vendor #1 using menu 1500.

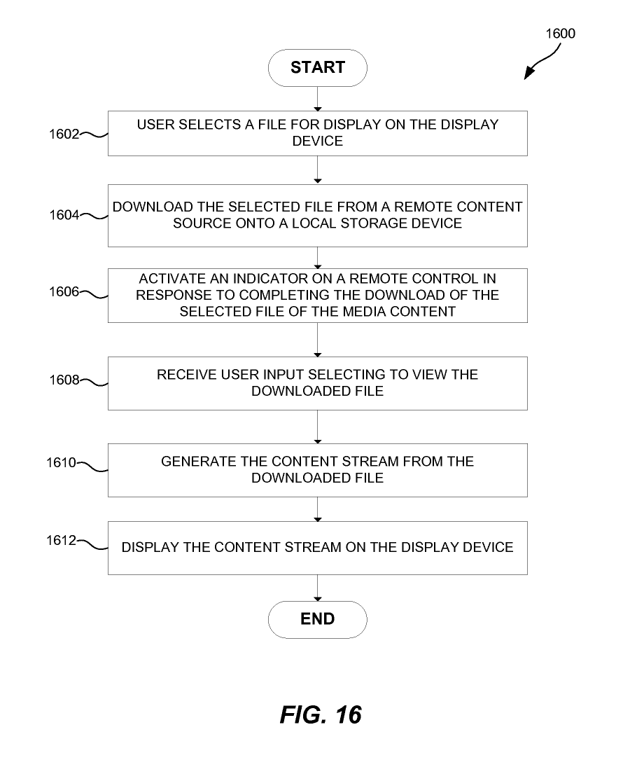

When user 135 purchases or otherwise acquires media content from remote content source 430, then media unit 410 may need to download the media content. FIG. 16 illustrates a method 1600 for downloading media content from a remote content source 430 in an exemplary embodiment of the invention. The steps of method 1600 will be described in reference to media system 400 of FIG. 4. The steps of method 1600 are not all-inclusive, and may include other steps not shown for the sake of brevity.

In step 1602 of FIG. 16, user 135 selects a file for display on display device 120. For example, assume that user 135 selects the file for a trailer of “Movie #2”, a sequel to “Movie #1”, in menu 1500 of FIG. 15. In step 1604 of FIG. 16, processing system 212 downloads the selected file from remote content source 430 onto local storage 416.

Since downloaded media content may not be immediately available for viewing, user 135 may desire for media unit 410 to provide notification when the download is complete. During the downloading process, user 135 may experience other media content on display device 120. In step 1606 of FIG. 16, processing system 212 activates an indicator (e.g., visual indicator 708 (see FIG. 7)) on remote control 130 responsive to completing the download of the selected file (or a predetermined partial completion of the download). The visual indicator 708 may be an LED, a display screen or other indicator which notifies user 135 when the download is complete. Alternatively, remote control 130 may include an audio indicator which notifies user 135 when the download is complete.

In step 1608, processing system 212 receives input from user 135 choosing to view the downloaded file. User 135 may then navigate a menu displayed on display device 120 by processing system 212 to begin viewing the downloaded media content. Alternatively, processing system 212 may be adapted to automatically display the downloaded media content on display device 120 once the download is complete. In step 1610 of FIG. 16, processing system 212 generates a content stream from the downloaded file. In step 1612 of FIG. 16, display device 120 displays the content stream on a display device 120. The content stream could be displayed on any display device 120 connected to media unit 110.

Media units 110, 410 and 510 may provide personalized functions, personalized searching, and personalized media content based on an identity of user 135. For example, each family member may have a separate account on media unit 110 with associated personalized settings. Media unit 110 may then personalize the viewing experience based on that particular user of media unit 110.

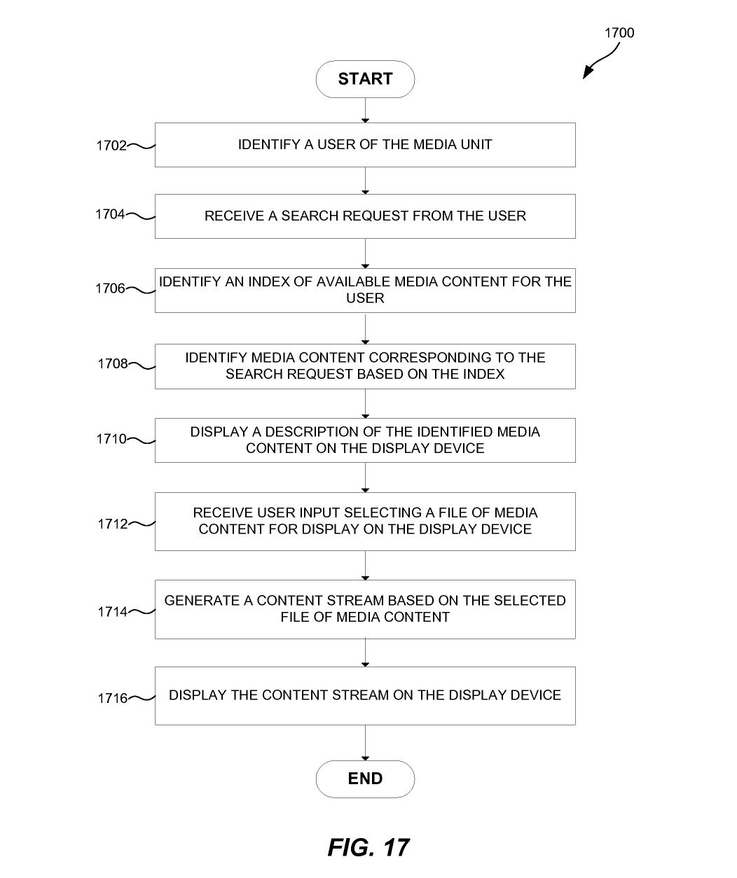

FIG. 17 illustrates a method 1700 for searching and for displaying media content based on a particular user of a media unit in an exemplary embodiment of the invention. Method 1700 will be discussed in reference to media system 400 illustrated in FIG. 4, and remote control 130 illustrated in FIG. 7. The steps of method 1700 are not all-inclusive, and may include other steps not shown for the sake of brevity.

In step 1702 of FIG. 17, processing system 212 identifies a user of media unit 410. The identification of the user may further authenticate the user to media unit 410. Thus, in one embodiment, the user may not be allowed to access and/or view media content on media unit 410 without proper authentication. Processing system 212 may identify user 135 based on personal information provided by user 135, such as a username, password or personal identification number (PIN). Alternatively, processing system 212 may identify user 135 based on biometric information, such as a fingerprint sample or a voiceprint sample.

For example, remote control 130 may include a fingerprint pad for receiving a fingerprint sample from user 135. Remote control 130 may further include processing circuitry adapted to identify user 135 based on the provided fingerprint sample. Alternatively, remote control 130 may transmit the fingerprint sample to media unit 110, and processing system 212 may then identify user 135 based on the provided fingerprint sample. Processing system, 212 may store a fingerprint sample of each user of media unit 410 for comparison to a fingerprint sample collected in step 1702. Processing system 212 may then compare the collected fingerprint sample to one or more stored fingerprint samples to identify user 135.

Remote control 130 may additionally or alternatively include microphone 702 of FIG. 7 for receiving a voiceprint sample from user 135. Remote control 130 may further include processing circuitry capable of identifying user 135 based on the provided voiceprint sample by using voice identification techniques. Alternatively, remote control 130 may transmit the voiceprint sample to media unit 410, and processing system 212 may then identify user 135 based on the provided voiceprint sample. Processing system 212 may store a voiceprint sample of each user of media unit 410 for comparison to a voiceprint sample collected in step 1702. Processing system 212 may then compare the collected voiceprint sample to one or more stored voiceprint samples to identify user 135.

In step 1704 of FIG. 17, interface system 214 receives a search request from user 135. In step 1706 of FIG. 17, processing system 212 identifies an index of available media content for user 135. The index may be compiled based on personal characteristics of user 135. For example, the index may be compiled based on viewing characteristics of user 135, prior searches conducted by user 135, prior purchases by user 135, user-provided information, user-selected media content, etc. The index may be persistently stored on local storage 416 for use during subsequent viewing sessions by user 135.

In step 1708 of FIG. 17, processing system 212 identifies media content corresponding with the search request based on the index identified in step 1706. For example, assume that the index for user 135 indicates that user 135 does not like watching cartoons. Assume further that user 135 searches for “detective” media content. Since user 135 doesn't like watching cartoons, the results for the search request may be filtered so the results do not include cartoon media content.

In step 1710 of FIG. 17, processing system 212 displays descriptions of the identified media content on display device 120. The descriptions of the identified media content may be personalized based on characteristics of user 135. For example, user 135 may not be interested in viewing a trailer for each file of media content, or viewing the quality of each file of media content. Thus, processing system 212 may tailor a displayed menu based on personal viewing characteristics of user 135.

In step 1712 of FIG. 17, processing system 212 receives user input selecting a file of media content for display on display device 120. In step 1714, processing system 212 generates a content stream based on the selected file of media content. The content stream may be generated based on personal characteristics of user 135 stored in the index. For example, the generated content stream may have an aspect ratio based on settings of user 135. In step 1716 of FIG. 17, processing system 212 displays the content stream on display device 120.

If media unit 410 knows the identity of user 135 and maintains an index of available media content based on personal characteristics of user 135, then media unit 410 may identify media content of interest to user 135 and display the identified media content to user 135 on display device 120.

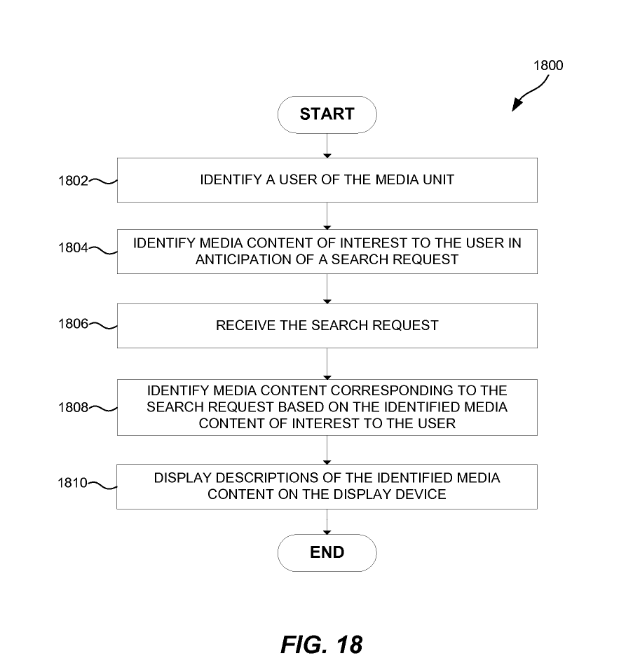

For example, media unit 410 may identify media content of interest to user 135 in anticipation of a search request. In other words, media unit 410 may have knowledge of media content that user 135 is likely to search for based on viewing habits of user 135, and may pre-search for media content based on this knowledge and maintain this information for future use. FIG. 18 illustrates a method 1800 for determining media content of interest to a particular user in anticipation of a search request in an exemplary embodiment of the invention. Method 1800 will be discussed in reference to media system 400 illustrated in FIG. 4, and remote control 130 illustrated in FIG. 7. The steps of method 1800 are not all-inclusive, and may include other steps not shown for the sake of brevity.

In step 1802 of FIG. 18, processing system 212 identifies a user of media unit 410, such as described in FIG. 1802 of FIG. 17. In step 1804 of FIG. 18, processing system 212 identifies media content of interest to user 135 in anticipation of a search request. For example, processing system 212 may query remote content sources 430-432 for media content likely to be of interest to user 135 when user 135 initially logs onto media unit 410. Processing system 212 may identify media content likely to be of interest to user 135 based on viewing habits of user 135 tracked in an index for user 135. The index may be compiled as described in step 1706 of FIG. 17.

This information is then stored for future use, such as when user 135 enters a search request. One such method of identifying media content of interest to user 135 includes identifying the media content based on time of day viewing habits of user 135. For example, media unit may determine that user 135 generally searches for a specific type of media content in the morning, and generally searches for a different type of media content in the evening. Thus, processing system 212 may determine the time of day, and then determine the types of media content that user 135 generally searches for at that time of day.

In step 1806 of FIG. 18, processing system 212 receives a search request for user 135. In step 1808 of FIG. 18, processing system 212 identifies media content corresponding with the search request based on the media content of interest to user 135 identified in step 1804. Thus, processing system 212 may provide user 135 with a subset of the media content identified in step 1804, with the subset of media content corresponding with the search request. In step 1810 of FIG. 18, processing system 212 displays descriptions of the identified media content from step 1808 on display device 120, and user 135 may select one or more files of the identified media content for display on display device 120.

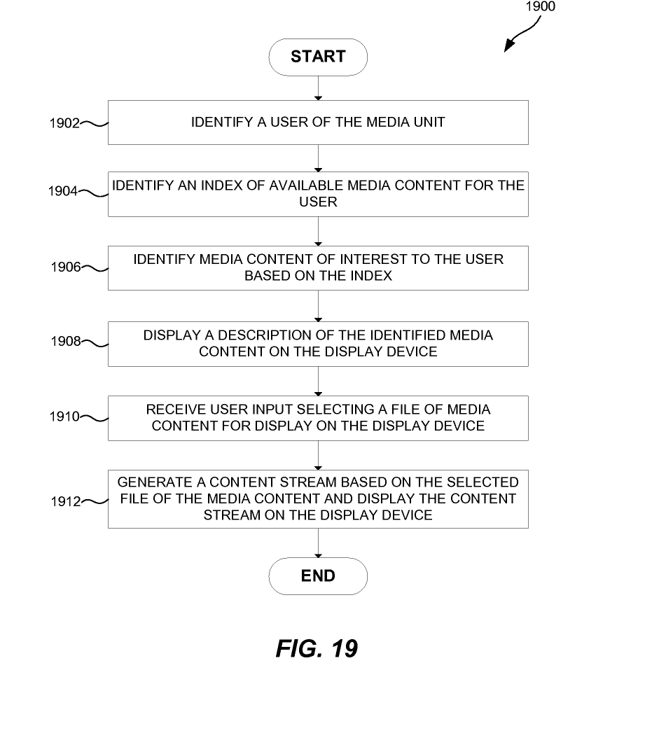

Further, media unit 410 may recommend media content to user 135. Therefore, user 135 does not need to always search for media content. Instead, media unit 410 may identify media content of interest to a user based on their previous viewing habits. FIG. 19 illustrates a method 1900 for identifying media content of interest to user 135 in an exemplary embodiment of the invention. Method 1900 will be described in reference to media system 400 in FIG. 4. The steps of method 1900 are not all-inclusive, and may include other steps not shown for the sake of brevity.

In step 1902 of FIG. 19, processing system 212 identifies user 135 of media unit 410. Processing system 212 may identify user 135 as described above in step 1702 of FIG. 17. In step 1904 of FIG. 19, processing system 212 identifies an index of available media content for user 135. Like as described above in step 1706 of FIG. 17, the index may be complied based on personal characteristics of user 135. Processing system 212 may track viewing habits of user 135 to determine media content of interest to user 135.

In step 1906 of FIG. 19, processing system 212 identifies media content of interest to user 135 based on the index. For example, assume that the index indicates that user 135 watches many horror movies. The index may include all of the horror movies that user 135 has viewed in conjunction with media unit 410. Processing system 212 may then query remote content source 430 to determine a list of all available horror movies. Processing system 212 may then identify horror movies that user 135 has not viewed, and recommend the identified movies to user 135 during a viewing session.

In step 1908 of FIG. 19, processing system 212 displays a description of the identified media content on display device 120. In the example described above, processing system 212 may display descriptions of the recommended horror movies which user 135 has not viewed on display device 120. In step 1910 of FIG. 19, interface system 214 receives user input selecting a file of media content for display on display device 120. In response, processing system 212 generates a content stream in step 1912 based on the selected file and displays the content stream on display device 120.

Processing system 212 may also be adapted to allow user 135 to save one or more files of media content displayed in step 1908 for later viewing. For example, media unit 410 may recommend three horror movies to user 135. User 135 may view one of the three horror movies in the present viewing session, and may bookmark the other two horror movies for later viewing during subsequent viewing sessions.

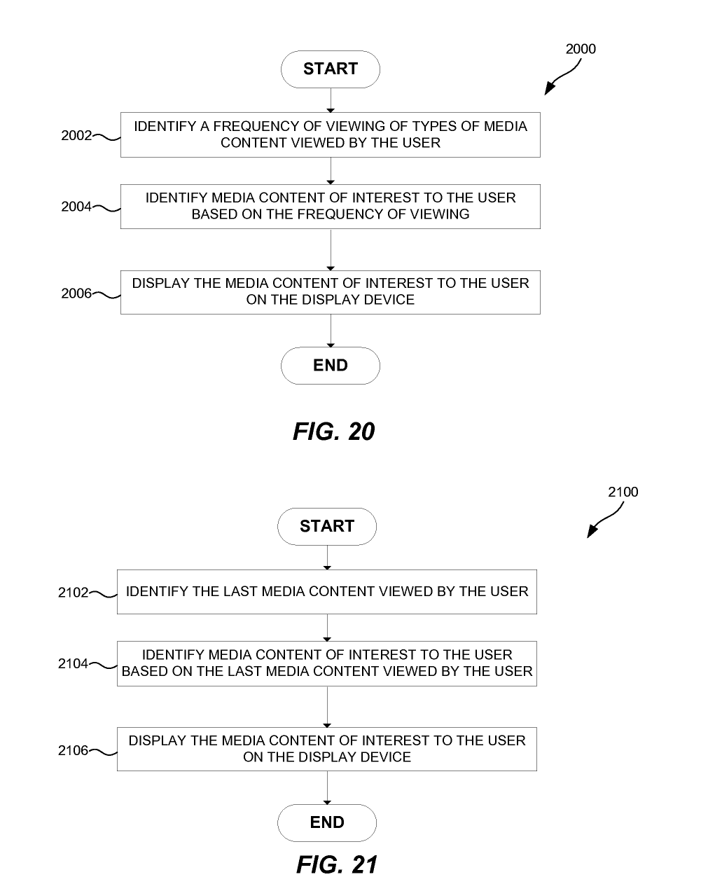

Processing system 212 may identify media content of interest to user 135 based on a variety of factors and personal characteristics of user 135. FIG. 20 illustrates a method 2000 for identifying media content of interest to user 135 based on a frequency of viewing of types of media content by user 135 in an exemplary embodiment of the invention. Method 2000 will be described in reference to media system 400 in FIG. 4. The steps of method 2000 are not all-inclusive, and may include other steps not shown for the sake of brevity.

In step 2002 of FIG. 20, processing system 212 identifies a frequency of viewing of types of media content viewed by user 135. For example, processing system 212 may identify that 50% of media content viewed by user 135 include action movies. If the index for user 135 maintained by processing system 212 tracks media content viewed by user 135, then processing system 212 may easily determine a frequency of viewing of types of media content by categorizing media content according to one or more categories. Processing system 212 may also be adapted to extract meta data and other information from television broadcasts regarding television viewing habits of user 135 to more accurately determine the frequency of viewing of types of media content viewed by user 135.

In step 2004 of FIG. 20, processing system 212 identifies media content of interest to user 135 based on the frequency of viewing determined in step 2002. For example, if user 135 views action movies 50% of the time, then processing system may identify action movies that user 135 has not viewed, and recommend those movies to user 135. Once processing system 212 identifies media content of interest to user 135, processing system 212 may display the media content of interest to user 135 on display device 120 in step 2006 of FIG. 20.

Processing system 212 may also determine media content of interest to user 135 based on the last media content viewed by user 135 during a previous viewing session. FIG. 21 illustrates a method 2100 for identifying media content of interest to user 135 based on the last media content viewed by user 135 in an exemplary embodiment of the invention. Method 2100 will be described in reference to media system 400 in FIG. 4. The steps of method 2100 are not all-inclusive, and may include other steps not shown for the sake of brevity.

In step 2102 of FIG. 21, processing system 212 determines the last media content viewed by user 135. For example, processing system 212 may determine the last movie, television broadcast, etc., viewed by user 135 in a prior viewing session previous to logging off from media unit 410. Processing system 212 may then identify media content of interest to user 135 in step 2104 based on the last media content viewed by user 135.

For example, processing system 212 may identify that user 135 last viewed a horror movie prior to logging off during the last viewing session, and may identify other horror movies that may be of interest to user 135. In step 2106 of FIG. 21, processing system 212 displays a description of the media content identified as of interest to user 135 on display device 120, and user 135 may then select a file of recommended media content for viewing on display device 120.

Processing system 212 may also identify media content of interest to user 135 based on other factors besides the last media content viewed by user 135. For example, processing system 212 may identify media content of interest to user 135 based on a last service channel of channel source 140 viewed by user 135. However, in some cases, user 135 may flip through several channels of channel source 140, and upon finding nothing of interest to watch, may switch off display device 120 or log off media unit 410. As such, it may be beneficial to determine media content of interest to user 135 based on a last service channel of channel source 140 viewed by user 135 for a minimum duration of time. The minimum duration of time may be for example 5 or 10 minutes. Thus, it is more likely that the last service channel viewed by user 135 is media content of interest to user 135, since they were not just flipping through the channels. This provides for a more accurate recommendation of media content of interest to user 135.

Previously, users wanting to purchase media content using their display device are typically restricted to a single vendor. For example, when a user purchases a pay-per-view movie on a cable television system, they are only able to purchase from a single vendor, which is typically the cable television provider. Thus, the user is not afforded the ability to purchase media content from multiple vendors who may have different prices and options available for purchasing media content. Further, when a user purchases a pay-per-view movie, they are typically limited to a single viewing, or viewing only within a specific time window (e.g., within 24 hours). As such, the user may not have the option to immediately purchase the movie under different license terms (e.g., paying an additional fee for a longer viewing window).

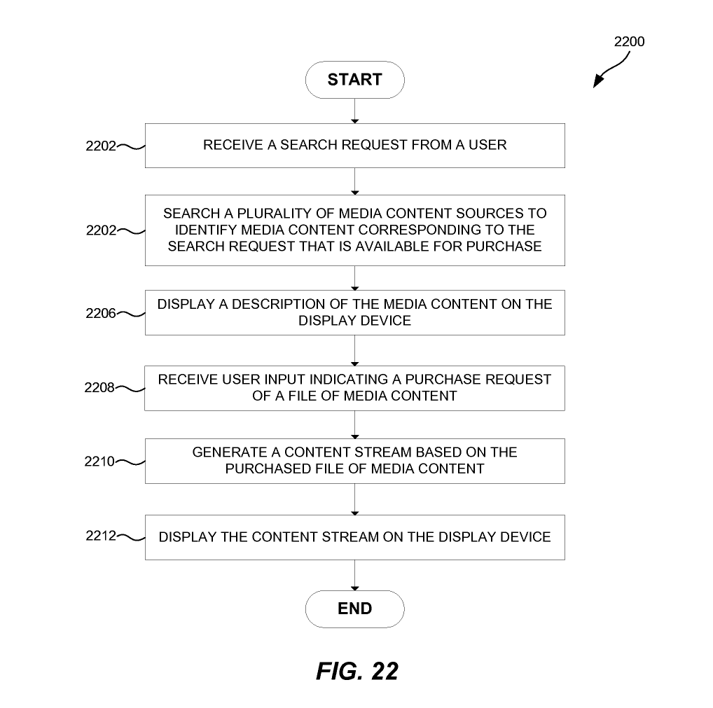

FIG. 22 illustrates a method 2200 for searching and for displaying media content available for purchase from a plurality of media content vendors in an exemplary embodiment of the invention. Method 2200 will be described in reference to media system 400 in FIG. 4. The steps of method 2200 are not all-inclusive, and may include other steps not shown for the sake of brevity.

In step 2202 of FIG. 22, interface system 214 receives a search request from user 135. Assume, for example, that user 135 desires to search for a copy of a specific movie. In step 2204 of FIG. 22, processing system 212 searches a plurality of media content sources (e.g., remote content source 430) to identify media content corresponding with the search request that is available for purchase from the media content sources.

In step 2206 of FIG. 22, processing system 212 displays a description of the identified media content on display device 120. The description of the media content may include a quality of the media content, a vendor of the media content, a price of the media content, and/or a preview of the media content (e.g., a trailer).

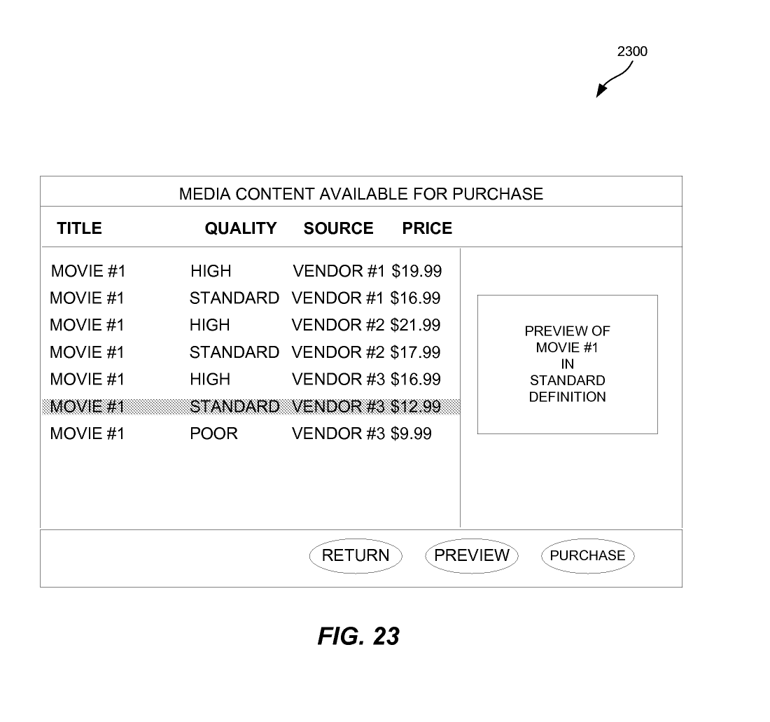

FIG. 23 illustrates an exemplary menu displaying media content identified as available for purchase by the method of FIG. 22 in an exemplary embodiment of the invention. Particularly, menu 2300 illustrates a movie available for purchase from a plurality of vendors (e.g., Vendor #1, Vendor #2 and Vendor #3). Further, user 135 may view a preview of a movie by selecting the file and pressing the “Preview” button.

In step 2208 of FIG. 22, interface system 214 receives user input indicating a purchase request of a file of media content from one of the vendors (e.g., remote content source 430). For example, using menu 2300, user 135 may purchase a file by selecting the file and pressing the “Purchase” button. Processing system 212 may then download the file to local storage 416 or buffer the file for local use. In step 2210 of FIG. 22, processing system 212 generates a content stream based on the purchased file of media content and displays the content stream on display device 120.

A purchase may also comprise delivery of tangible goods to a user. For example, a user may be provided with a movie poster, DVD, promotional item, etc., relating to media content purchased in step 2208. The method may optionally include collecting delivery information from the user (e.g., an address), and delivering tangible goods as part of the purchase request.

When making purchases using media unit 410, it may become cumbersome for user 135 to enter payment information each time a purchase is made. Further, it may be desirable for each family member to be allocated with a specific amount of money during a specific time period (e.g., one month) with which to purchase media content from media content sources as described by method 2200 of FIG. 22. Thus, it may be beneficial to provide users of media unit 410 with debit accounts with which the users may make purchases of media content.

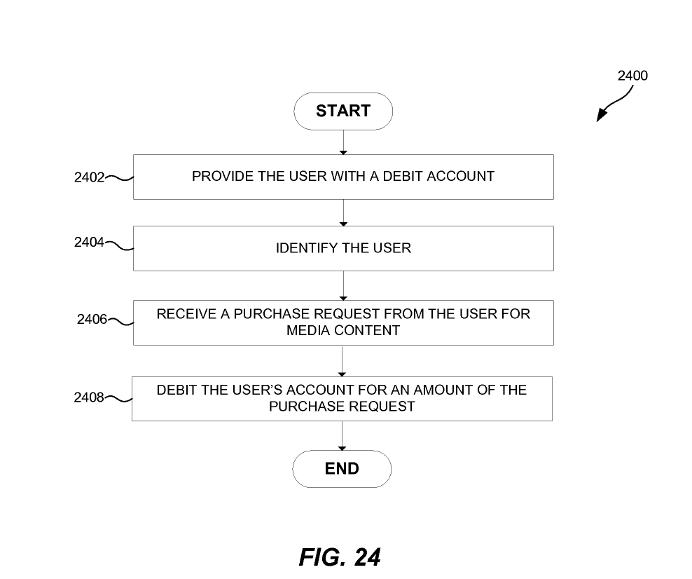

FIG. 24 illustrates a method 2400 for purchasing media content using a debit account of a user 135 of a media unit in an exemplary embodiment of the invention. The steps of method 2400 will be described in reference to media system 400 described in FIG. 4. The steps of method 2400 are not all-inclusive, and may include other steps not shown for the sake of brevity.

In step 2402 of FIG. 24, media unit 110 provides user 135 with a debit account. Each user of media unit 410 may have a separate debit account, or some users may have a debit account while other users are not allowed to make purchases using media unit 410. Debit accounts may have a pre-determined periodic limit (e.g., a user may spend $50 per month) which the user may not exceed. For example, parents may provide children with a pre-set limit each month. Further, the debit account may restrict what media content the account holder may purchase. Thus, parents may control how much their children spend on media content each month, as well as the specific media content their children may purchase.

In step 2404 of FIG. 24, processing system 212 identifies user 135. For example, processing system 212 may identify user 135 based on information provided by user 135, such as a username and/or PIN. Alternatively, processing system 212 may identify user 135 based on biometric information as described above.

In step 2406 of FIG. 24, processing system 212 receives a purchase request from user 135 for a file of media content. Purchase requests have a corresponding purchase amount. A purchase may be denied if the debit account does not contain funds sufficient to cover the amount of the purchase request. Additionally, a purchase request may be denied if the user's debit account prohibits the purchase of the requested file of media content. For example, processing system 212 may deny a child's purchase of an R-rated movie if the debit account indicates that user 135 may not purchase R-rated media content. In step 2408 of FIG. 24, processing system 212 debits the user's account for an amount of the purchase request.

Media unit 410 may also be adapted to allow user 135 to search for and to purchase tangible goods using display device 120. Searching for tangible goods may be done in conjunction with searching for media content. Thus, media unit may display descriptions of tangible goods corresponding with a search request for media content in the same menus as the descriptions of the media content. Alternatively, media unit 410 may display descriptions of tangible goods available for purchase and corresponding with a search request even when user 135 is not searching for media content.

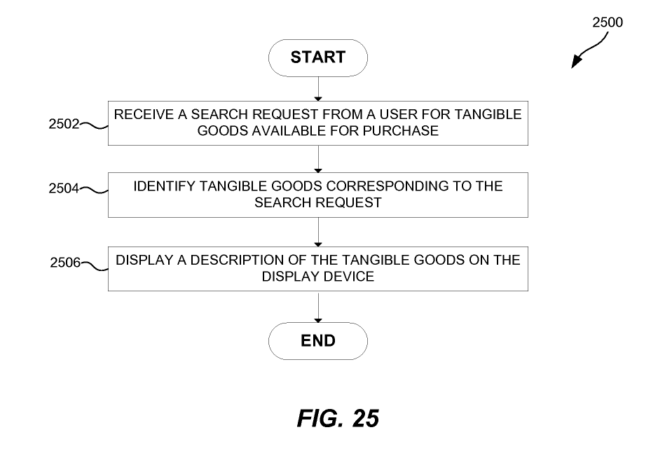

FIG. 25 illustrates a method 2500 for searching and for displaying on a display device tangible goods available for purchase in an exemplary embodiment of the invention. The steps of method 2500 will be described in reference to media system 400 described in FIG. 4. The steps of method 2500 are not all-inclusive, and may include other steps not shown for the sake of brevity.

In step 2502 of FIG. 25, interface system 214 receives a search request from user 135 for tangible goods available for purchase. Tangible goods may be any type of goods available for purchase by user 135. For example, tangible goods may include action figures or memorabilia related to a movie. Other exemplary tangible goods may include tools, sporting goods, food, etc. which may correspond to media content experienced by user 135.

User 135 may input the search request using remote control 130 in a similar manner as described above in regard to inputting a search request for media content. Processing system 212 may display one or more menus on display device 120 which allow user 135 to navigate and to search for tangible goods which are available for purchase.

In step 2504 of FIG. 25, processing system 212 identifies tangible goods corresponding with the search request which are available for purchase. To identify tangible goods available for purchase, processing system 212 may query remote servers which maintain information regarding tangible goods available for purchase from one or more vendors.

In step 2506 of FIG. 22, processing system 212 displays a description of the tangible goods on display device 120. The description of the tangible goods, as well as prices, vendor information, purchase information, etc., may be provided within a user navigable menu displayed on display device 120.

In one embodiment, processing system 212 may display tangible goods available for purchase in conjunction with a search request by user 135 for media content. For example, assume that user 135 searches for media content related to a superhero movie. Processing system 212 may identify media content corresponding with the superhero movie. Additionally, media unit 110 may identify tangible goods, such as action figures, corresponding with the superhero movie. The identified tangible goods may be displayed in a menu on display device 120 together with the identified media content corresponding with the search request.

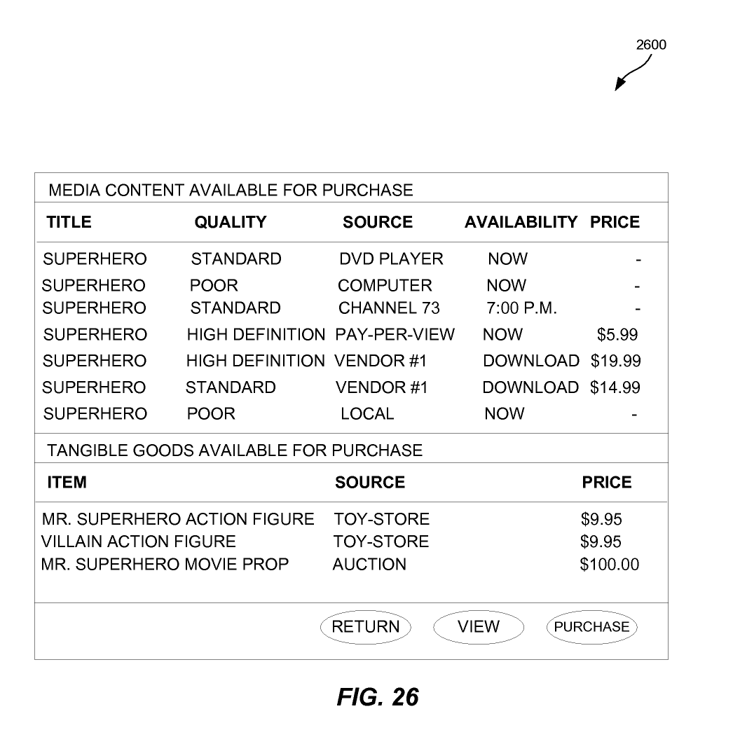

FIG. 26 illustrates an exemplary menu 2600 displaying media content corresponding with a search request which is available for viewing, and displaying tangible goods corresponding with the search request available for purchase in an exemplary embodiment of the invention. The top panel of menu 2600 displays media content available for viewing by user 135 (e.g., on television, on local drives, and available for purchase). User 135 may then select one file of media content for viewing.

The bottom panel of menu 2600 displays tangible goods corresponding with the search request which are available for purchase from various vendors. As illustrated, user 135 may view an action figure related to the superhero movie by highlighting the item and pressing the “View” button. User 135 may also take other actions, such as completing a purchase of one or more of the tangible goods identified in step 2504 of FIG. 25.

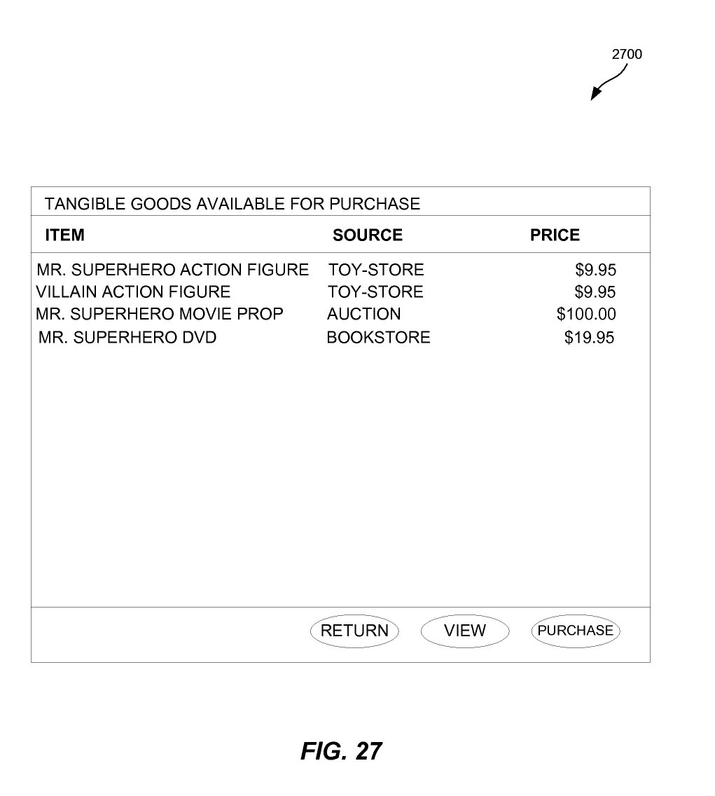

Alternatively, a user may be provided with a menu displaying tangible goods corresponding with a search request, but the menu may not display non-tangible media content available for purchase. FIG. 27 illustrates an exemplary menu 2700 displaying tangible goods corresponding with the search request available for purchase in an exemplary embodiment of the invention. For example, a user may specifically search for Mr. Superhero products, such as action figures, trading cards and other tangible goods. Menu 2700 illustrates that a user may purchase a Mr. Superhero DVD. Tangible goods may also include media content distributed on a physical medium, such as DVDs, CDs, etc. Thus, vendors could provide users the opportunity to purchase media content in both downloadable and physical formats. For example, a user could purchase media content embodied on a physical medium (e.g., a DVD) using media unit 410.

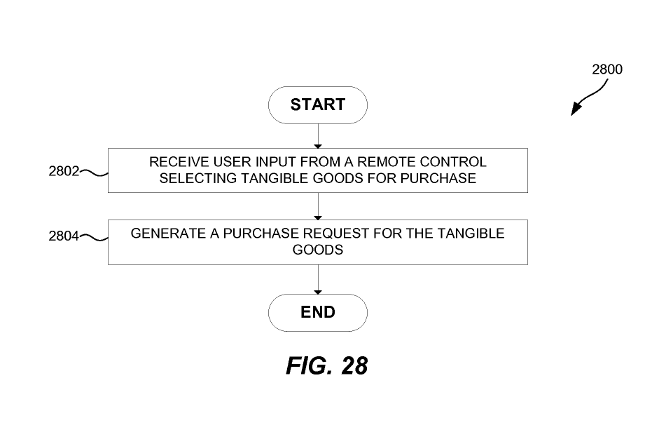

FIG. 28 illustrates a method 2800 for completing a purchase of tangible goods identified as available for purchase by method 2500 of FIG. 25 in an exemplary embodiment of the invention. The steps of method 2800 will be described in reference to media system 400 illustrated in FIG. 4. The steps of method 2800 are not all-inclusive, and may include other steps not shown for the sake of brevity.

In step 2802 of FIG. 28, interface system 214 receives user input from remote control 130 selecting tangible goods for purchase. For example, user 135 may highlight the Mr. Superhero action figure displayed in menu 2600 of FIG. 26 and press the “Purchase” button.

In step 2804 of FIG. 28, processing system 212 generates a purchase request for the tangible goods selected by user 135 in step 2802. For example, after pressing the “Purchase” button in menu 2600 of FIG. 26, user 135 may view additional menus to complete the purchase request. The additional menus may allow user 135 to provide payment information, shipping information, etc. User 135 may also use a debit account associated with media unit 410 to complete the purchase request. Thus, user 135 may purchase both tangible goods and media content using the same debit account. This simplifies the amount of information that user 135 needs to enter to complete purchases of either types of products.

As further illustrated in menu 2600 of FIG. 26, there is one item which is available from an electronic auction service. Media unit 410 may be further adapted to interface with an electronic auction service. Tangible goods available for purchase through an electronic auction service and corresponding with a search request for media content may be displayed on display device 120 by processing system 212. Thus, user 135 may use remote control 130 to search auctions, place bids, etc., through the electronic auction service.

If user 135 is participating in electronic auctions, then media unit 410 may also be adapted to display messages relating to these electronic auctions on display device 120. For example, user 135 may be a bidder in an electronic auction, and may be outbid by another user. The electronic auction service may notify media unit 410, and processing system 212 may display an outbid message on display device 120. There are other notifications which the electronic auction service may provide media unit 410 for display on display device 120. User 135 may then be given the option to visit the electronic auction service using remote control 130 to take additional action, such as placing a new bid on an item.

These types of messages may be correlated to a specific user logged into media unit 410. Thus, media unit 410 may not display a message for User A while User B is logged in to media unit 410 and watching media content on display device 120. Further, messages may be overlaid onto the present program displayed on display device 120, such as in a picture-in-picture configuration, a “crawler”, etc., so as to not interrupt the viewing of media content.

These messages may be pushed to media unit 410 by the electronic auction service, or may be pulled from the electronic auction service by media unit 410 once a user logs onto media unit 410. These messages may be further pulled from the electronic auction service based on other events occurring within media unit 410 or at pre-determined time intervals defined on media unit 410. Other exemplary messages of user specific media content displayed on display device 120 include stock quotes, news, sports scores and stats, fantasy sports updates, etc.

Although specific embodiments were described herein, the scope of the invention is not limited to those specific embodiments. The scope of the invention is defined by the following claims and any equivalents therein.

We claim:

1. A method for searching and for displaying media content on a display device over an un-modulated service channel of a building cable infrastructure, the method comprising:
receiving a search request from a user;
identifying media content corresponding with the search request;
displaying a description of the media content on the display device over the un-modulated service channel, wherein the description of the media content is modulated over the un-modulated service channel;
receiving user input selecting at least one file of the media content for display on the display device;
generating a content stream based on the selected at least one file of the media content; and
displaying the content stream on the display device over the un-modulated service channel, wherein the content stream is modulated over the un-modulated service channel.

2. The method of claim 1, wherein the un-modulated service channel comprises an un-modulated service channel of a channel source coupled to the building cable infrastructure.

3. The method of claim 1, wherein receiving the search request from the user further comprises:
receiving the search request from a remote control operated by the user.

4. The method of claim 3, wherein receiving the search request from the remote control further comprises:
receiving user input comprising a voice command, wherein the user inputs the voice command into the remote control; and
translating the voice command into the search request.

5. The method of claim 3, wherein receiving the search request from the remote control further comprises:
receiving user input comprising a handwriting sample of the user, wherein the user inputs the handwriting sample using a motion transducer in the remote control; and
translating the handwriting sample into the search request.

6. The method of claim 1, wherein identifying the media content corresponding with the search request further comprises:
identifying locally-stored media content corresponding with the search request.

7. The method of claim 1, wherein identifying the media content corresponding with the search request further comprises:
querying a remote media content source for media content corresponding with the search request.

8. The method of claim 1, wherein identifying the media content corresponding with the search request and displaying the description of the media content on the display device over the un-modulated service channel further comprises:
identifying a broadcast time and a broadcast channel of a broadcast corresponding with the search request; and
displaying the broadcast time and the broadcast channel of the broadcast on the display device.

9. The method of claim 8, wherein displaying the broadcast time and the broadcast channel of the broadcast on the display device is performed responsive to a determination that the broadcast time is within a pre-determined time window.

10. The method of claim 1, wherein identifying the media content corresponding with the search request further comprises:
identifying media content stored on a peripheral device.

11. The method of claim 10, wherein the peripheral device is one of a digital video disk (DVD) player, a digital video recorder (DVR), an optical disk player, an external storage device or a computer.

12. The method of claim 1, wherein identifying the media content corresponding with the search request further comprises:
identifying media content available for purchase from a plurality of vendors.

13. The method of claim 12, wherein receiving the user input selecting the at least one file of the media content for display on the display device further comprises:
receiving user input indicating a purchase request of at least one file of media content from at least one of the plurality of vendors.

14. The method of claim 13 further comprising:
providing the user with a debit account; and
debiting the debit account for an amount of the purchase.

15. The method of claim 1 further comprising:
identifying the user based on biometric information of the user.

16. The method of claim 15, wherein the biometric information includes a fingerprint of the user.

17. The method of claim 15, wherein the biometric information includes a voiceprint sample of the user.

18. The method of claim 1, wherein identifying the media content corresponding with the search request further comprises:
filtering the media content based on personal characteristics of the user.

19. The method of claim 1, wherein displaying the description of the media content on the display device further comprises:
displaying a preview of the media content on the display device over the un-modulated service channel.

20. The method of claim 1, wherein generating the content stream further comprises:
downloading the selected at least one file of the media content from a remote media content source onto a local storage device; and
generating the content stream from the downloaded at least one file of the media content.

21. The method of claim 20 further comprising:
activating an indicator on a remote control responsive to completing the download of the selected at least one file of the media content.

22. The method of claim 20 further comprising:
activating an indicator on a remote control responsive to completing a predetermined partial download of the selected at least one file of the media content.

23. The method of claim 1 further comprising:
identifying tangible goods available for purchase and corresponding with the search request for media content; and
displaying on the display device over the un-modulated channel a description of tangible goods available for purchase.

24. The method of claim 23 further comprising:
receiving user input indicating a purchase request of at least one of the tangible goods.

25. The method of claim 24 further comprising:
providing a user with a debit account; and
debiting the debit account for an amount of the purchase request.

26. The method of claim 25, wherein the tangible goods are available for purchase through an electronic auction service.

27. The method of claim 1 further comprising:
activating an indicator on a remote control to notify the user of an occurrence of an event regarding the user.

28. The method of claim 27, wherein the event corresponds to a status change regarding an auction of an electronic auction service.

29. A method for searching and for displaying on a television tangible goods available for purchase using a media unit, the media unit adapted to provide media content to the television, the method comprising:
receiving a search request from a user for tangible goods available for purchase, wherein the user inputs the search request using a remote control for the television;
identifying tangible goods corresponding with the search request using the media unit;
displaying a description of the tangible goods on the television;
receiving user input selecting at least one of the tangible goods for purchase; and
generating a purchase request for the selected at least one of the tangible goods.

30. The method of claim 29, wherein displaying the description of the tangible goods on the television further comprises:
displaying the description of the tangible goods on the television over an un-modulated service channel of a channel source coupled to a building cable infrastructure and coupled to the television, wherein the description of the tangible goods is modulated over the un-modulated service channel.

31. The method of claim 29 further comprising:
providing the user with a debit account; and
debiting the debit account for an amount of the purchase request.

32. The method of claim 29, wherein the tangible goods are available for purchase through an electronic auction service.

33. The method of claim 29 further comprising:
activating an indicator on a remote control to notify the user of a status change regarding an auction of the electronic auction service.

34. A media unit for searching and for displaying media content on a display device over an un-modulated service channel of a building cable infrastructure, the media unit comprising:
an interface system adapted to receive a search request from a user; and
a processing system coupled to the interface system and coupled to the display device through the building cable infrastructure and adapted to:
identify media content corresponding with the search request;
display a description of the media content on the display device over the un-modulated service channel, wherein the description of the media content is modulated over the un-modulated service channel, and
wherein the interface system is further adapted to receive user input selecting at least one file of the media content for display on the display device, and
wherein the processing system is further adapted to:
generate a content stream based on the selected at least one file of the media content; and
display the content stream on the display device over the un-modulated service channel, wherein the content stream is modulated over the un-modulated service channel.

35. The media unit of claim 34, wherein the un-modulated service channel comprises an un-modulated service channel of a channel source coupled to the building cable infrastructure.

36. The media unit of claim 34, wherein the interface system is further adapted to receive the search request from a remote control operated by the user.

37. The media unit of claim 36, wherein:
the interface system is further adapted to receive user input comprising a voice command, wherein the user inputs the voice command into the remote control; and
the processing system is further adapted to translate the voice command into the search request.

38. The media unit of claim 36, wherein:
the interface system is further adapted to receive user input comprising a handwriting sample of the user, wherein the user inputs the handwriting sample using a motion transducer in the remote control; and
the processing system is further adapted to translate the handwriting sample into the search request.

39. The media unit of claim 34, wherein the processing system is further adapted to identify locally-stored media content corresponding with the search request.

40. The media unit of claim 34, wherein the processing system is further adapted to query a remote media content source for media content corresponding with the search request.

41. The media unit of claim 34, wherein the processing system is further adapted to:
identify a broadcast time and a broadcast channel of a broadcast corresponding with the search request; and
display the broadcast time and the broadcast channel of the broadcast on the display device.

42. The media unit of claim 41, wherein the processing system is further adapted to display the broadcast time and the broadcast channel of the broadcast on the display device responsive to a determination that the broadcast time is within a pre-determined time window.

43. The media unit of claim 34, wherein the processing system is further adapted to identify media content stored on a peripheral device.

44. The media unit of claim 43, wherein the peripheral device is one of a digital video disk (DVD) player, a digital video recorder (DVR), an optical disk player, an external storage device or a computer.

45. The media unit of claim 34, wherein the processing system is further adapted to identify media content available for purchase from a plurality of vendors.

46. The media unit of claim 45, wherein the interface system is further adapted to receive user input indicating a purchase request of at least one file of media content from at least one of the plurality of vendors.

47. The media unit of claim 46, wherein the media unit further includes a debit account corresponding with the user, and the processing system is further adapted to debit the debit account for an amount of the purchase.

48. The media unit of claim 34, wherein the processing system is further adapted to identify the user based on biometric information of the user.

49. The media unit of claim 48, wherein the biometric information includes a fingerprint of the user.

50. The media unit of claim 48, wherein the biometric information includes a voiceprint sample of the user.

51. The media unit of claim 34, wherein the processing system is further adapted to filter the media content based on personal characteristics of the user.

52. The media unit of claim 34, wherein the processing system is further adapted to display a preview of the media content on the display device over the un-modulated service channel.

53. The media unit of claim 34, wherein the media unit further comprises a storage device, and the processing system is further adapted to:
download the selected at least one file of the media content from a remote media content source onto the storage device; and
generate the content stream from the downloaded at least one file of the media content.

54. The media unit of claim 53, wherein the processing system is further adapted to activate anindicator on a remote control responsive to completing the download of the selected at least one file of the media content.

55. The media unit of claim 53, wherein the processing system is further adapted to activate an indicator on a remote control responsive to completing a predetermined partial download of the selected at least one file of the media content.

56. The media unit of claim 34, wherein the processing system is further adapted to:
identify tangible goods available for purchase and corresponding with the search request for media content; and
display on the display device over the un-modulated channel a description of tangible goods available for purchase.

57. The media unit of claim 56, wherein the interface system is further adapted to:
receive user input indicating a purchase request of at least one of the tangible goods.

58. The media unit of claim 56, wherein the processing system is further adapted to:
provide a user with a debit account; and
debit the debit account for an amount of the purchase request.

59. The media unit of claim 56, wherein the tangible goods are available for purchase through an electronic auction service.

60. The media unit of claim 34, wherein the processing system is further adapted to:
activate an indicator on a remote control to notify the user of an occurrence of an event regarding the user.

61. The media unit of claim 60, wherein the event corresponds to a status change regarding an auction of an electronic auction service.

62. A media unit for searching and for displaying on a television tangible goods available for purchase, the media unit adapted to provide media content to the television, the media unit comprising:
an interface system adapted to receive a search request from a user for tangible goods available for purchase, wherein the user inputs the search request using a remote control for the television;
a processing system coupled to the display device and coupled to the interface system, the processing system adapted to:
identify tangible goods corresponding with the search request using the media unit; and
display a description of the tangible goods on the television, and
wherein the interface system is further adapted to receive user input selecting at least one of the tangible goods for purchase; and
wherein the processing system is further adapted to generate a purchase request for the selected at least one of the tangible goods.

63. The media unit of claim 62, wherein the processing system is further adapted to display the description of the tangible goods on the television over an un-modulated service channel of a channel source coupled to a building cable infrastructure and coupled to the television, wherein the description of the tangible goods is modulated over the un-modulated service channel.

64. The media unit of claim 62, wherein the processing system is further adapted to:
provide the user with a debit account; and
debit the debit account for an amount of the purchase request.

65. The media unit of claim 62, wherein the tangible goods are available for purchase through an electronic auction service.

66. The media unit of claim 65, wherein the processing system is further adapted to:
activate a indicator on a remote control to notify the user of a status change regarding an auction of the electronic auction service.
